(19) United States
(12) Patent Application Publication
(10) Pub. No.: US 2026/0286074 A1
(43) Pub. Date: Sep. 24, 2026

(54) Reinforced Thermoplastic Composite from Pelletized Cotton Waste and a Method of Manufacturing the Same

(71) Applicant: Bernastic, LLC, Atlanta, GA (US)

(72) Inventor: Michael Bernstein, Atlanta, GA (US)

(21) Appl. No.: 19/372,340

(22) Filed: Oct. 29, 2025

Related U.S. Application Data
(63) Continuation-in-part of application No. 19/292,961, filed on Aug. 7, 2025.
Application No. 19/292,961 is a continuation of application No. 19/086,676, filed on Mar. 21, 2025.

(51) Int. Cl. C08J 5/04; B29B 9/06; B29B 13/06; B29K 23/00; B29K 311/10; B33Y 70/10; C08L 23/06; C09D 7/40; C09D 7/65; C09D 123/06

(52) U.S. Cl. CPC C08J 5/045; B29B 9/065; B29B 13/065; B33Y 70/10; C08J 5/046; C08L 23/06; C09D 7/65; C09D 7/70; C09D 123/06; B29K 2023/065; B29K 2311/10; C08J 2323/06; C08L 2203/30; C08L 2205/16; C08L 2207/062; C08L 2207/20

(57) ABSTRACT

A pelletized cotton waste formulation is disclosed for use in thermoplastic composite manufacturing. The formulation comprises airborne yarn waste and/or cotton waste dust obtained from pre-consumer textile fabrication, a natural or synthetic binder selected from starch, lignin, dextrin, or a biodegradable polymer configured to enhance pellet cohesion, and a densified pelletized structure formed by mechanical or hydraulic compression into discrete pellets. The pellets are characterized by uniform geometry, controlled moisture, and structural integrity, making them suitable for automated feeding into a polymer compounding extruder. The formulation improves material handling, feed consistency, and dispersion of cotton fibers in a thermoplastic polymer matrix such as high-density polyethylene (HDPE), polypropylene (PP), or polyethylene terephthalate (PET). When compounded with a compatibilizing bonding agent, the pellets form reinforced thermoplastic composites exhibiting enhanced tensile strength, stiffness, and sustainability.

### FIELD OF THE INVENTION

The present invention relates to the field of thermoplastic composite materials, and more particularly to pelletized cotton waste formulations, methods of manufacturing such pellets, and methods of forming reinforced thermoplastic composites utilizing the pellets. The invention further relates to systems and processes for compounding pelletized cotton waste with thermoplastic polymers and bonding agents to produce reinforced composites suitable for molding, extrusion, or three-dimensional (3D) printing applications. The invention provides an eco-friendly, lightweight, and high-performance composite material derived from pre-consumer textile waste, exhibiting enhanced mechanical, thermal, and odor-neutralizing properties.

### BACKGROUND

### Interpretation Considerations

This section describes the technical field in detail and discusses problems encountered in the technical field. Therefore, statements in the section are not to be construed as prior art.

### Discussion

The rise of fast fashion has significantly increased the production and disposal of clothing, leading to a surge in textile waste and global pollution. Globally, the fashion industry is responsible for approximately 10% of carbon emissions, 20% of industrial water pollution, and extensive land and resources used for fiber production. Despite advancements in recycling technologies, less than 1% of clothing is recycled into new textiles, with most apparel waste ending up in landfills or being incinerated, exacerbating environmental harm. Though textile recycling methods have evolved, the effective reuse and recycling of both pre-consumer (manufacturing scraps) and post-consumer (discarded clothing) apparel waste still remain unresolved. Cotton-based materials, which are widely used in the production of textiles, generate substantial amounts of apparel waste during various processing stages. This waste is often discarded or underutilized, leading to resource inefficiencies and environmental harm.

Recycling waste apparel from textile fabrication presents significant challenges due to the low-density and amorphous nature of cotton waste or airborne yarn waste. These characteristics make transportation inefficient, as the material is bulky, lightweight, and prone to entanglement, requiring extensive handling and large storage volumes. The same issues also create challenges when feeding into compounding processes for reinforced composites. Its irregular structure prevents smooth and consistent feeding, leading to poor dispersion within the composite matrix. Unlike granular or pelletized reinforcements, cotton waste resists uniform mixing, resulting in material inconsistencies that compromise the biomechanical properties of the final composite. These processing difficulties limit the scalability and practicality of using cotton waste in advanced material applications.

The patent WO202150228A1 focuses on utilizing recycled post-consumer waste to produce reinforced composite materials, specifically emphasizing the collection and processing of fibrous waste from discarded textiles and plastics rather than pre-consumer yarn waste or other pre-consumer waste. The process involves harvesting post-consumer waste through municipal or industrial collection, sorting to remove contaminants, and converting it into a usable form for compounding with resins or binders. However, post-consumer waste presents several manufacturing and operational inefficiencies. Feeding post-consumer cotton into compounding machines also poses challenges due to its physical form, as loose, lightweight fibers do not disperse uniformly within the polymer matrix, leading to inconsistent fiber distribution and reduced composite performance. Additionally, post-consumer fibers often retain dyes, chemical treatments, and contaminants from prior use, which can negatively affect the final composite properties. Removing or neutralizing these chemicals requires additional processing steps such as washing, bleaching, or chemical treatments, increasing complexity and cost.

Beyond the transportation challenges, achieving uniform dispersion of reinforcement materials within a polymer matrix is critical to ensuring optimal mechanical properties. However, when cotton or other recycled textiles are used, they exhibit poor dispersion rates when blended with thermoplastic polymers such as high-density polyethylene (HDPE). The fibrous structure results in uneven distribution within the molten polymer, leading to inconsistencies in the final composite material. This poor integration can result in weak points, reducing the overall strength and durability of the composite.

Existing solutions for recycling cotton fiber focus on low-value applications, such as insulation or padding materials. These methods fail to leverage the potential of pre-consumer apparel waste for creating durable materials with enhanced properties, such as improved tensile strength or rigidity. Furthermore, there is a lack of cost-effective and scalable technologies capable of transforming this underutilized resource into valuable products.

The integration of natural fibers such as cotton lint or cotton waste into thermoplastic polymers has garnered significant interest in recent years, driven by the need for sustainable, biodegradable, and cost-effective composite materials. These bio-composites are increasingly used in a variety of applications, including automotive components, packaging, construction materials, and consumer goods, due to their favorable mechanical properties, renewability, and reduced environmental footprint. However, a major technical challenge encountered during the manufacturing of such composites, particularly when utilizing extrusion processes, is the generation of undesirable and persistent foul odors in the end product or final composite or compositions.

Despite growing attention toward sustainable composite manufacturing, the physical characteristics of fibrous cotton waste remain a significant technical bottleneck. The material's low bulk density, entangled morphology, and non-uniform particle size distribution make it difficult to compact, transport, meter, or feed consistently into extrusion and compounding equipment. These limitations lead to inefficient handling, process interruptions, and variable fiber distribution during thermoplastic blending. Moreover, the absence of a standardized or densified form factor for fibrous textile waste restricts scalability and reproducibility in industrial processing.

In addition, inconsistencies in fiber moisture content, residual air entrapment, and mechanical instability during storage or transport further hinder reliable integration of cotton-based waste into thermoplastic systems. These factors collectively reveal a void in the art for a reliable, transportable, and process-compatible form of cotton waste that can be easily introduced into thermoplastic compounding processes while maintaining consistent quality, dispersion, and performance characteristics.

### SUMMARY

An objective of the present invention is to provide an apparatus and method for compacting airborne yarn waste and, or cotton waste dust into a cotton waste plug. By incorporating a cotton waste plug into the composite, the material exhibits higher tensile strength, making it suitable for a wide range of applications where durability is crucial.

Another advantage of the present invention is the formation of a compact cotton waste plug by converting the airborne yarn waste and, or cotton waste dust into a plug form. This transformation makes the transportation of cotton waste much more efficient and cost-effective. By minimizing the volume of the waste, it becomes easier to handle and transport from one location to another, thereby reducing logistical costs and environmental impact.

An objective of the present invention is to provide a reinforced thermoplastic composite with a charcoal additive and method for producing the same to provide improved odor control, and superior durability compared to conventional thermoplastic composites.

Yet another objective of the present invention is to enable efficient, scalable manufacturing of durable, eco-friendly components for diverse industrial applications.

Cotton waste dust and airborne yarn waste (dust/waste) are two distinct types of pre-consumer cotton waste materials that serve as inputs for the compaction process to create cotton waste plugs. Cotton waste dust is a fine particulate byproduct generated during the combing process, where short fibers, broken fragments, and impurities are separated from longer staple fibers to enhance yarn quality. This dust, collected through extraction and filtration systems, is reintroduced into the spinning process to create yarn, maximizing fiber utilization. In contrast, airborne yarn waste consists of larger fiber clusters, stray filaments, and lint that become detached and suspended in the air during fabrication processes such as spinning, weaving, and knitting. This waste, which is captured through air filtration systems, represents an additional input for cotton waste plug production. Both cotton waste dust and airborne yarn waste are inputs for the compaction process, where they are compressed into cotton waste plugs for downstream reinforced composite manufacturing. Optionally, the cotton waste plug may be compacted from either input alone.

Furthermore, the present invention offers reduced production costs. By leveraging waste materials and optimizing manufacturing processes, the cost of producing these composites is significantly lower than traditional methods, making them more accessible to industries seeking sustainable solutions.

Additionally, the present invention boosts the reusability and value of airborne yarn waste and, or cotton waste dust. By transforming this underutilized resource into durable end products, the invention contributes to resource efficiency and waste reduction, aligning with sustainable development goals.

This and other objectives are achieved by providing a system, an apparatus and a method for manufacturing a cotton waste plug and a blended composition with the features in the independent claims.

According to the first aspect of the present invention, the present invention provides a cotton waste plug from airborne yarn waste and, or cotton waste dust. The cotton waste plug comprises airborne yarn waste and, or cotton waste dust collected by vacuuming through a negative air environment. Further, the waste/dust is compacted into a cotton waste plug shape configured for at least one of ease of transport and storage.

In another embodiment of the present invention, the cotton waste plug is processed into a plug shape by vacuuming waste/dust from the air through a negative air environment and compacting the waste/dust into a cylindrical shape. The waste/dust is compacted into the plug shape using at least one of mechanical pressing, hydraulic compression, extrusion-based densification, thermal bonding, or chemical binding agents.

In one embodiment of the present invention, the formation of the cotton waste plug is not a result of deliberate compaction, post-processing, or secondary shaping steps. Instead, the plug assumes its final form as a natural consequence of the manufacturing process. Specifically, the system utilizes a negative air pressure environment to collect dust/waste, directing it through a controlled airflow system into a compaction chamber where it is consolidated into a cylindrical shape. As the continuous column of compacted waste/dust exits the processing apparatus through tubing or piping, gravitational forces cause the material to segment naturally into discrete, uniformly shaped plugs. The inherent structural integrity of the compacted cotton fibers, combined with the controlled exit conditions, ensures that the plugs break off with consistent dimensions, texture, and mechanical properties, eliminating the need for additional processing steps to achieve the final shape.

In yet another embodiment of the present invention, the cotton waste plug further comprises a humidity level of less than 10%.

According to a second aspect of the invention, the invention provides an apparatus for manufacturing a cotton waste plug. The apparatus comprises an input source unit, a plunger unit and an output unit. The input source unit receives and vacuums the waste/dust from the air through a negative air environment. The plunger unit compacts the received waste/dust. The output unit compacts and outputs the waste/dust into a plug shape.

In an embodiment of the present invention, the plunger unit compacts the waste/dust into the plug shape using at least one of mechanical pressing, hydraulic compression, extrusion-based densification, thermal bonding, or chemical binding agents.

In an embodiment of the present invention, the output unit includes a shaping die structure to output the compacted plug in any desired shape and dimension.

According to a third aspect of the present invention, the invention provides a method of manufacturing a cotton waste plug. The method comprises the steps of a) obtaining airborne yarn waste/cotton waste dust from pre-consumer industrial sources; and b) compacting the dust/waste into a plug shape using at least one of mechanical pressing, hydraulic compression, extrusion-based densification, thermal bonding, or chemical binding agents.

In yet another aspect of the present invention, the plug shape is further combined with a thermoplastic polymer and bonding agent to produce a reinforced composite material.

In yet another aspect of the present invention, the airborne yarn waste and cotton waste dust may be collected and combined with the thermoplastic polymer and bonding agent to produce the reinforced composite material, without the need to form the yarn waste/cotton waste dust into a plug shape or cotton waste plug.

In one embodiment of the present invention, the reinforced composite material is outputted as pellets from the compounding process, ensuring uniform dispersion of the cotton waste fibers within the thermoplastic polymer matrix. The incorporation of the cotton waste plug-derived fibers into the polymer results in enhanced bio-mechanical properties, including improved tensile strength, impact resistance, and flexural modulus. The natural fiber reinforcement contributes to increased durability and load-bearing capacity, making the composite material suitable for demanding structural applications. Additionally, the inherent characteristics of cotton fibers, such as their low density and ability to enhance thermal and acoustic insulation, further expand the material's potential applications.

Once formed into pellets, the reinforced composite material can be subsequently injection molded into a wide range of end-use consumer and industrial products. Potential applications include durable pallets for logistics and shipping, eco-friendly furniture components, hangers, automotive interior panels, construction materials such as decking boards and wall panels, and consumer goods like storage bins, tool handles, and packaging materials. The ability to efficiently integrate airborne yarn waste and, or cotton waste dust into thermoplastic composites not only improves the sustainability of these end-products but also contributes to circular economic efforts by repurposing textile waste into high-performance materials.

According to a fourth aspect of the present invention, the present invention provides a reinforced composite material. The reinforced composite material comprises airborne yarn waste and/or cotton waste dust (waste/dust) in a plug form, a bonding agent, a thermoplastic polymer, and a charcoal additive. The airborne yarn waste and/or cotton waste dust is compounded with the thermoplastic polymer, bonding agent, and charcoal additive to form a reinforced composite material. The use of waste materials and additives results in a cost-effective, environmentally friendly composite material with enhanced tensile strength.

In an embodiment of the present invention, the charcoal additive comprises at least one of an activated charcoal, biochar, or carbon black derived from biomass or recycled organic material. The use of charcoal additives from sustainable sources further enhances the environmental benefits and imparts improved adsorption, filtration, and mechanical properties to the composite material.

In another embodiment of the present invention, the charcoal additive is provided in a particulate form selected from powder, granules, or micronized particles suitable for uniform mixing during compounding. The particulate form of the charcoal additive ensures homogeneous dispersion within the composite material, thereby enhancing its structural integrity and functional performance.

In another embodiment of the present invention, the charcoal additive is present in an amount ranging from 0.5% to about 2.5% by weight of the total composition. Optimizing the charcoal additive content within this range provides a balance between improved functional properties and cost-effectiveness, without adversely affecting the processability or mechanical strength of the composite material.

In still another embodiment of the present invention, the charcoal additive is introduced during compounding by at least one of pre-mixing with the fiber plug, blending with the thermoplastic polymer or bonding agent, or via a dedicated feeder into the compounding system. The flexible methods of introducing the charcoal additive enable efficient integration and uniform distribution within the composite material, thereby optimizing its performance and manufacturability.

In yet another embodiment of the present invention, the charcoal additive is introduced during the compounding process by at least one of premixing with the fiber plug prior to feeding, co-feeding into the melt zone through a dedicated feeder, or pre-blending with the polymer resin prior to compounding. These versatile introduction methods ensure thorough and consistent incorporation of the charcoal additive, resulting in a reinforced composite material with enhanced uniformity and optimized functional properties.

In yet another embodiment of the present invention, the plug form of waste/dust, bonding agent, thermoplastic polymer, and charcoal additive are blended in a melt compounding process using at least one of a twin-screw extruder, continuous mixer, or batch mixer. The feeding scheme is configured to enable uniform distribution of each component. The compressed plugs are introduced at a primary feed location, and the charcoal additive is introduced either simultaneously through a co-feeder or downstream into the mixing zone to promote homogeneous distribution. The controlled feeding and melting compounding process ensures optimal dispersion of all components, leading to a reinforced composite material with consistent quality, superior mechanical properties, and reliable performance.

In yet another embodiment of the present invention, the compounded composition is pelletized via an extrusion process to form pellets suitable for downstream molding, forming, or additive manufacturing. This enhances material handling, storage, and processability, enabling efficient and versatile use in various manufacturing applications.

In still another embodiment of the present invention, the compounded composition is extruded into a continuous filament or string form suitable for spooling and use in three-dimensional printing processes. Thereby expanding the material's utility for advanced manufacturing and rapid prototyping.

According to a fifth aspect of the present invention, the present invention provides a method for producing a reinforced composite material. The method comprises the steps of a) collecting airborne yarn waste and/or cotton waste dust (waste/dust); b) forming the airborne yarn waste and/or cotton waste dust into a plug form; c) feeding the plug into a compounding system; d) introducing a thermoplastic polymer, a bonding agent, and a charcoal additive into the compounding system; and e) compounding the waste/dust, thermoplastic polymer, bonding agent, and charcoal additive under heat and shear to produce a reinforced composite material. The method enables efficient recycling of textile waste into high-value composite materials, promoting sustainability and resource conservation while delivering enhanced material performance.

In an embodiment of the present invention, the step of forming the plug includes densifying the waste/dust and compacting it using at least one of mechanical pressing, hydraulic compression, extrusion-based densification, thermal bonding, or chemical binding agents. This improves handling efficiency, reduces material loss, and ensures consistent feed quality for the subsequent compounding process.

In another embodiment of the present invention, the thermoplastic polymer comprises at least one of high-density polyethylene (HDPE), polypropylene (PP), polyethylene terephthalate (PET), low-density polyethylene (LDPE), polycarbonate (PC), acrylonitrile butadiene styrene (ABS), polylactic acid (PLA), or polyamide (PA). The use of a wide range of thermoplastic polymers allows for versatility in tailoring the composite material's properties for diverse applications.

In still another embodiment of the present invention, the charcoal additive is introduced into the compounding system by at least one of (a) pre-blending with the fiber plug, (b) independent feeding using a gravimetric or volumetric feeder, or (c) blending with the thermoplastic polymer prior to introduction. The use of multiple introduction methods for the charcoal additive ensures flexible processing and consistent dispersion within the composite.

In still another embodiment of the present invention, the compounding system comprises at least one of a twin-screw extruder, continuous mixer, or batch mixer, and the components are introduced through at least one or more feed inlets arranged to ensure even mixing. Optimized mixing equipment and feed arrangements promote uniform blending, resulting in a composite material with consistent quality and properties.

In another embodiment of the present invention, further comprising the step of pelletizing the compounded material by extruding the blended composition through a die, cooling the extrudate in a water bath, and cutting into pellets. This facilitates easy handling, storage, and downstream processing of the composite material.

In still another embodiment of the present invention, further comprising drying the pelletized material to remove residual moisture before any molding or forming operation. This prevents defects and ensures optimal quality during subsequent molding or forming processes.

In yet another embodiment of the present invention, further comprising molding the dried, pelletized material into a structural article by at least one of injection molding, compression molding, or extrusion molding. This allows the pelletized material to efficiently convert into a variety of structural products using standard molding techniques.

In still another embodiment of the present invention, further comprising extruding the compounded composition into a continuous string or filament and winding onto a spool for use in three-dimensional (3D) printing. This expands the application in advanced manufacturing.

In yet another embodiment of the present invention, the resulting composite material includes uniformly dispersed fibers and charcoal additive, and exhibits improved structural strength, dimensional stability, or thermal performance as compared to compositions without the charcoal additive. The presence of the charcoal additive significantly enhances the overall tensile strength of the composite material and reduces mitigate foul odors.

In still another embodiment of the present invention, the charcoal additive provides at least one of antimicrobial or odor-absorbing properties to the reinforced composite material. The composite material gains added functional benefits such as improved hygiene and odor control.

In yet another embodiment of the present invention, the charcoal additive is derived from pyrolyzed agricultural waste selected from at least one of coconut shells, rice husks, bamboo, or walnut shells. Sourcing the charcoal from agricultural waste supports sustainability and adds value to discarded biomass.

In yet another embodiment of the present invention, the pyrolyzed charcoal is further activated via steam or chemical treatment to increase surface area and porosity. The activated charcoal provides enhanced adsorption capacity, improving the composite's functional properties.

In still another embodiment of the present invention, the charcoal additive has a particle size distribution between 10 microns and 150 microns to promote dispersion during melt compounding. The optimal particle size distribution ensures uniform dispersion and maximizes the reinforcing effect of the charcoal additive.

In yet another embodiment of the present invention, the charcoal additive is surface-treated with a compatibilizer or dispersing agent to enhance bonding with the thermoplastic matrix. This improves interfacial adhesion, leading to better mechanical properties of the composite.

In yet another embodiment of the present invention, the presence of the charcoal additive improves thermal conductivity or flame resistance of the final reinforced composite.

According to a sixth aspect of the present invention, the present invention provides a method of producing a charcoal-infused fiber plug for subsequent use in composite material manufacturing. The method comprises the steps of a) collecting airborne yarn waste and/or cotton waste dust (waste/dust); b) mixing the airborne yarn waste and/or cotton waste dust with a charcoal additive to form a fiber-charcoal blend; c) densifying the fiber-charcoal blend; d) compacting the densified blend into a plug-like structure; and e) supplying the plug to a downstream processing system for compounding with a thermoplastic polymer and a bonding agent. The method streamlines the integration of recycled fibers and charcoal additives, enabling efficient production of sustainable, high-performance composite materials and mitigating foul odors.

In one example, the charcoal additive is provided and fed in the form of pellets, each pellet having a controlled size and shape to facilitate uniform distribution and integration within the composite material during compounding.

According to the seventh aspect of the present invention, the present invention provides a method for producing a reinforced composite filament for 3D printing. The method comprises the steps of: (a) collecting airborne yarn waste and/or cotton waste dust; (b) compounding the waste/dust with high-density polyethylene (HDPE) to form a composite melt; (c) extruding the composite melt through a die to form a continuous filament; (d) injecting compressed air into the filament either during compounding or immediately after extrusion; and (e) spooling the filament for feeding into a 3-D printer.

In an embodiment of the present invention, the method further comprises the step of adding a charcoal additive comprised of at least one of activated charcoal, biochar, or carbon black derived from biomass or recycled organic matter for enhancing tensile strength and stiffness of the composite filament while imparting odor absorption.

In another embodiment of the present invention, the air injection is performed using an air-jet apparatus to interlace the composite material, forming air-injected yarn-like reinforcement to improve filament cohesion and enhance mechanical bonding. Further, surface roughness or texture provides better feed grip in 3D printers.

In another embodiment of the present invention, the compounding occurs at a melt temperature of about 250° C. and die temperature of about 240° C. This ensures optimal mixing and flow properties, resulting in a homogeneous material with improved mechanical performance.

In another embodiment of the present invention, the filament is extruded through a 1-2 mm die and sized to a final diameter of approximately 1.8 mm to 1.95 mm. This provides consistent filament dimensions, which enhances print quality and reliability in additive manufacturing applications.

In another embodiment of the present invention, the charcoal additive is present in the composition in an amount ranging from 0.5 wt % to 1.5 wt %. This controlled addition of charcoal optimizes the balance between mechanical strength and functional properties, such as odor absorption or antimicrobial activity.

In yet another embodiment of the present invention, the method further comprises cooling the filament and storing it in an airtight container with desiccant to prevent moisture absorption and brittleness.

In still another embodiment of the present invention, the filament is compatible with FFF (Fused Filament Fabrication) 3D printers using nozzles of 0.8 mm or greater, and is resistant to clogging or delamination during printing.

According to the eighth aspect of the present invention, the present invention provides a method for reinforcing a bio-filled 3D printing filament. The method comprises the steps of: (a) feeding a compounded composite including HDPE, 15-35 wt % cotton waste fibers, and a charcoal additive into an extrusion system; (b) injecting compressed air into the compounding or extrusion zone to form interlaced or air-covered structures along the filament length; and (c) controlling draw-down and spooling while the filament remains pliable to prevent breakage and maintain dimensional uniformity.

In an embodiment of the present invention, the compressed air is introduced through nozzles positioned at the extrusion outlet to produce turbulence and interlacing for a textured and slightly entangled surface.

In another embodiment of the present invention, the air-injection apparatus is synchronized with the filament take-up speed to ensure consistent reinforcement and reduce tension-induced breakage.

In yet another embodiment of the present invention, the interlaced regions formed by air injection reduce brittleness caused by over-drying, excessive fiber content, or improper print settings.

In still another embodiment of the present invention, the method further comprising optical monitoring of filament diameter and interlace distribution during spooling to ensure uniformity and quality control.

According to the ninth aspect of the present invention, the present invention provides a system for producing reinforced composite filament for 3D printing. The system comprises an extrusion line, a temperature-controlled extrusion die, a draw-down roller assembly, an air-injection apparatus, a synchronized filament winder, a programmable logic controller (PLC), a valve timing module, a sensor module, and a humidity-controlled storage chamber. The extrusion line is configured to process a composite material containing polymer, fiber waste, and a charcoal additive. The temperature-controlled extrusion die is configured to form the composite into a continuous filament. The draw-down roller assembly positioned downstream of the die to regulate filament tension and diameter. The air-injection apparatus comprising a ring of radial micro-nozzles arranged to direct compressed air around the filament to create circumferential interlacing. The synchronized filament winder for collecting the filament under controlled conditions. The programmable logic controller (PLC) configured to regulate extrusion speed, filament cooling, and air-injection timing. The valve timing module operatively connected to the air-injection apparatus to generate periodic reinforcement points along the filament. The sensor module is configured to monitor and log filament temperature, tension, and interlacing consistency. The humidity-controlled storage chamber for storing the filament spool to prevent moisture absorption and preserve filament quality.

In an embodiment of the present invention, the extrusion line comprises a twin-screw extruder configured with multiple heating zones for enhanced dispersion of the fiber and charcoal additive within the polymer melt. This results in superior homogeneity and consistent material properties throughout the filament.

In another embodiment of the present invention, the temperature-controlled extrusion die includes integrated thermocouples and PID controllers to maintain a die temperature within ±3° C. of a setpoint to ensure filament dimensional stability. This precise temperature control minimizes dimensional variation and improves the quality of the final filament.

In another embodiment of the present invention, the draw-down roller assembly comprises motorized rollers with adjustable speed control and a feedback tension system for maintaining a constant filament cross-section during draw-down. This ensures uniform filament thickness and reduces the risk of defects during production.

In another embodiment of the present invention, the synchronized filament winder includes an automatic traversing mechanism and variable torque control to evenly distribute filaments across the spool and prevent slack or deformation. This results in neatly wound spools and prevents tangling or deformation of the filament during storage and use.

In another embodiment of the present invention, the air-injection apparatus is supplied by a regulated compressed air source operating at a pressure between 1.5 and 4 bar and includes directional nozzles positioned at an oblique angle to induce spiral interlacing along the filament surface to prevent separation of the filament from itself or other adjacent filaments. This improves filament cohesion and handling, reducing the likelihood of filament breakage or separation.

In another embodiment of the present invention, the micro-nozzles in the air-injection apparatus are arranged in a 360-degree circular array and configured to deliver timed pulses of compressed air to form discrete reinforcement points without disrupting filament geometry. This provides localized reinforcement for enhanced filament strength without compromising its shape or printability.

In another embodiment of the present invention, the programmable logic controller (PLC) includes a touch-screen interface and is programmed to dynamically adjust extrusion parameters in response to feedback from the sensor module. This enables real-time process optimization, resulting in consistently high-quality filament production.

In another embodiment of the present invention, the valve timing module is synchronized with the draw-down roller speed and is programmed to deliver air bursts at regular intervals based on filament linear velocity to create structured filaments for stronger interlayer adhesion. This enhances the bonding strength between printed layers, improving the mechanical integrity of 3D-printed objects.

In another embodiment of the present invention, the sensor module comprises at least one optical micrometer for measuring filament diameter, a thermal imaging sensor for real-time surface temperature detection, and a load cell for tracking filament tension in view of efficient pulling and winding of the filament. This comprehensive monitoring ensures optimal process control and reduces the risk of production errors.

In another embodiment of the present invention, the sensor module transmits real-time data to the PLC, which adjusts extrusion line speed, air-jet timing, and winder torque to ensure consistent filament properties. This closed-loop control system maintains uniform filament quality and minimizes material waste.

In yet another embodiment of the present invention, the humidity-controlled storage chamber maintains an internal relative humidity below 15% using desiccant cartridges and active moisture sensors. This prevents moisture absorption, thereby preserving the filament's mechanical properties and printability.

In still another embodiment of the present invention, the storage chamber further comprises temperature regulation, automated sealing, and a logging system for tracking environmental conditions and alerting operators to storage events. This ensures optimal storage conditions and provides traceability, reducing the risk of filament degradation.

According to one aspect, the present invention provides a pelletized cotton waste formulation for use in thermoplastic composite manufacturing. The formulation comprises airborne yarn waste and/or cotton waste dust obtained from pre-consumer textile fabrication, along with a densified pelletized structure formed by mechanical or hydraulic compression of the waste/dust into discrete pellets configured for feeding into a polymer compounding extruder. This pelletized structure increases bulk density, reduces dust and bridging, and enables consistent feeding into polymer compounding extruders, thereby improving handling and overall processability. In an embodiment of the present invention, the formulation further comprises a natural or synthetic binder configured to promote inter-fiber adhesion and maintain pellet cohesion during transport. This improves pellet integrity, reduces fines and feed interruptions during handling and dosing, increasing yield and line uptime.

In another embodiment of the present invention, the pellets have a generally cylindrical or prismatic shape. They are configured with bulk density and dimensional uniformity, making them suitable for automated metering, stock shipping, and mechanical conveying without disintegration. This provides Consistent geometry and density, enhances hopper flowability and dosing precision while lowering breakage and dust generation in logistics and processing.

In another embodiment of the present invention, the formulation further comprises a charcoal additive selected from activated charcoal, biochar, or carbon black derived from recycled or biomass sources. This incorporates recycled/biogenic carbons, which imparts functional performance, valorizes waste streams, and can improve mechanical and thermal stability in polymer composites.

In yet another embodiment of the present invention, the charcoal additive imparts odor-absorbing, antimicrobial, or flame-resistant functionality to a resulting composite material. This provides multifunctional properties that enable hygiene-and safety-oriented applications by combining adsorption, antimicrobial potential, and flame/heat resistance in a single material system.

In yet another embodiment of the present invention, the pellet surface is physically compacted or densified to reduce friability and minimize dust generation during handling and storage. This lower friability reduces housekeeping, exposure risks, and material loss, improving EHS compliance and overall material efficiency.

According to another aspect, the present invention provides a method for manufacturing pelletized cotton waste. The method comprises the steps of a) collecting airborne yarn waste and/or cotton waste dust from pre-consumer textile fabrication; b) pre-grinding and drying the collected material; c) mixing the material with a binder; d) compressing the conditioned material by mechanical or hydraulic densification to form discrete pellets; and e) cooling and packaging the pellets for downstream compounding. The standardized pellet production creates a stable, supply chain-ready feedstock that reduces variability and simplifies scalable compounding operations.

In an embodiment of the present invention, the densification is performed using at least one of mechanical pressing, hydraulic compression, extrusion-based densification, or thermal bonding. Multiple densification modes provide process flexibility to accommodate fiber morphology, moisture state, and equipment constraints while achieving target strength and density.

In another embodiment of the present invention, the pellets are cooled and screened to remove fines and maintain dimensional uniformity. Cooling and classification improve feeding consistency and reduce die wear and downtime associated with fines and out-of-spec pellets.

In another embodiment of the present invention, the pelletized material is stored in sealed or moisture-controlled packaging configured for stock shipping and extended storage stability. The moisture managed storage preserves processability and mechanical properties by limiting hydrolysis and degradation in hygroscopic fiber-filled systems.

According to another aspect, the present invention provides a reinforced thermoplastic composite. The reinforced thermoplastic composite comprises a thermoplastic polymer, a bonding agent, and pelletized cotton waste comprising airborne yarn waste and/or cotton waste dust obtained from pre-consumer textile fabrication, the waste being densified by mechanical or hydraulic compression into discrete pellets; wherein the pellets are compounded with the thermoplastic polymer and bonding agent to form a reinforced composite material. The approach upgrades low-value textile byproducts into reinforced composites with improved stiffness and strength, as well as circular economy benefits.

In an embodiment of the present invention, the bonding agent comprises a maleic-anhydride-grafted polymer or compatibilizer. MA grafted compatibilizers enhance fiber-matrix adhesion, increasing tensile and flexural performance at practical natural fiber loadings.

In another embodiment of the present invention, the thermoplastic polymer is selected from high-density polyethylene, polypropylene, polyethylene terephthalate, polycarbonate, polylactic acid, or polyamide. This provides compatibility with commodity and engineering thermoplastics, broadens application spaces and processes across molding and extrusion.

In another embodiment of the present invention, the composite further comprises a charcoal additive introduced during compounding to enhance tensile strength and odor control. Biochar/activated carbon fillers can deliver mechanical uplift alongside odor adsorption without complex chemistries or costly additives.

In yet another embodiment of the present invention, the charcoal additive is derived from pyrolyzed agricultural waste, including coconut shells, rice husks, bamboo, or walnut shells. Using agri-residue biochar's supports circularity and carbon retention while creating value-added polymer composites.

In yet another embodiment of the present invention, the compounded composition is pelletized through extrusion to form pellets configured for molding, extrusion, or three-dimensional printing. Pelletized composites provide flexible inventory management and drop-in compatibility with standard compounding and forming lines

In still another embodiment of the present invention, the compounded composition is alternatively extruded into a continuous filament suitable for spooling and additive-manufacturing applications. Continuous composite filaments enable FDM printing of natural fiber parts on standard desktop and industrial printers.

According to yet another aspect, the present invention provides a method for producing a reinforced composite material. The method comprises the steps of a) forming a plug or pellet of airborne yarn waste and/or cotton waste dust; b) feeding the plug or pellet into a compounding system; c) introducing a thermoplastic polymer and a bonding agent; and d) compounding the components under heat and shear to produce a reinforced composite. The integrated flow from waste capture to compounding reduces handling steps and costs while improving throughput and uniformity.

In another embodiment of the present invention, the method further comprises pelletizing the compounded material and drying the pellets before molding or extrusion. Post-pelletization drying enhances surface finish and mechanical consistency by mitigating moisture-induced defects during forming.

In another embodiment of the present invention, the method further comprises molding or extruding the dried pellets to form an article. Leveraging conventional molding/extrusion equipment streamlines adoption and scales production without specialized capital investment.

According to another aspect of the present invention, the invention provides a method for manufacturing pelletized cotton waste, including the steps of collecting airborne yarn waste and cotton waste dust, pre-grinding and drying the material, conditioning with a binder, densifying the conditioned material through a ring-die or flat-die pellet mill, cooling and screening the pellets, and packaging them for downstream use. The method enhances yield uniformity, reduces fines and handling losses, and produces a densified material compatible with high-throughput thermoplastic processing systems.

According to another aspect of the present invention, the invention provides a reinforced thermoplastic composition comprising a thermoplastic polymer selected from high-density polyethylene (HDPE), polypropylene (PP), or polyethylene terephthalate (PET); a bonding agent comprising a maleic-anhydride-grafted polymer or compatibilizer; and the pelletized cotton waste as herein described. The pellets are uniformly dispersed within the polymer matrix to form a composite exhibiting enhanced tensile strength, flexural modulus, and dimensional stability. The densified structure of the pellets enables uniform fiber distribution and improved interfacial adhesion within the polymer phase.

In one embodiment, the method of compounding further comprises introducing an odor-neutralizing additive selected from activated charcoal, biochar, or zeolite, the additive being fed separately into the compounding system to reduce volatile emissions and improve odor control in the final composite. The composite may further include fillers such as porcelain, quartz, or feldspar to increase rigidity or wear resistance.

According to yet another aspect of the invention, the compounded composition may be pelletized for downstream molding or extruded into filament form for use in three-dimensional (3D) printing. The filament derived from the pelletized cotton-waste composite provides lightweight, eco-friendly, and functional material suitable for fused-filament-fabrication systems, exhibiting improved feed uniformity, mechanical strength, and odor-absorptive performance.

Further yet, the pellets serve as an intermediate feedstock that can be efficiently blended with various thermoplastic matrices for producing molded articles, profiles, or sheets using conventional extrusion or injection-molding equipment. The form and composition of the pellets minimize fiber agglomeration and promote repeatable compounding across production runs, thereby overcoming feed and dispersion challenges encountered with loose fibrous waste.

These additional embodiments collectively address the deficiencies of existing low-density cotton-waste feed materials by providing a densified, process-compatible form that improves material handling, mixing uniformity, and composite performance while maintaining the sustainability advantages of textile-waste utilization.

Further objectives, features, and advantages of the present invention will become apparent when studying the following detailed disclosure, the drawings, and the appended claims. Those skilled in the art will realize that different features of the present invention can be combined to create embodiments other than those described in the following.

### BRIEF DESCRIPTION OF THE DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention and should not be taken as limiting its scope. With this caveat, embodiments of the invention will be described and explained with additional specificity and detail through the use of the accompanying drawings in which:

FIG. 1 illustrates a system for forming a reinforced composite material in accordance with an embodiment of the present invention;

FIG. 2 illustrates an apparatus for manufacturing a cotton waste plug in accordance with an embodiment of the present invention;

FIG. 3 illustrates sub-modules of a system for forming a reinforced composite material in accordance with an embodiment of the present invention;

FIG. 4 illustrates an injection molding module of a system in accordance with an embodiment of the present invention;

FIG. 5 illustrates test results of the final reinforced composite after pelletizing and before injection molding in accordance with an embodiment of the present invention;

FIG. 6 illustrates test results of the final reinforced composite after pelletizing and before injection molding in accordance with an embodiment of the present invention;

FIG. 7 illustrates a method flow diagram for manufacturing a cotton waste plug in accordance with an embodiment of the present invention;

FIG. 8 illustrates a method flow diagram for forming a blended composition in accordance with an embodiment of the present invention;

FIG. 9 illustrates a method flow diagram for injection molding a blended composition to form an end product in accordance with an embodiment of the present invention;

FIG. 10 (A) illustrates a system for forming a reinforced composite material in accordance with an embodiment of the present invention;

FIG. 10 (B) illustrates a result of Young's modulus performed on the thermoplastic polymer blend containing 25% cotton in accordance with an embodiment of the present invention;

FIG. 10 (C) illustrates a result of specific gravity performed on the thermoplastic polymer blend containing 25% cotton in accordance with an embodiment of the present invention;

FIG. 11 illustrates a method for producing a reinforced composite material in accordance with an embodiment of the present invention;

FIG. 12 illustrates a method for producing a charcoal-infused fiber plug for subsequent use in composite material manufacturing in accordance with an embodiment of the present invention;

FIG. 13 illustrates a system for producing a reinforced composite filament for 3D printing in accordance with an embodiment of the present invention;

FIG. 14 illustrates a method for producing a reinforced composite filament for 3D printing in accordance with an embodiment of the present invention; and

FIG. 15 illustrates a method for reinforcing a bio-filled 3D printing filament in accordance with an embodiment of the present invention.

FIG. 16 is a schematic flow diagram illustrating an exemplary process for manufacturing pelletized cotton waste from pre-consumer airborne yarn waste and cotton waste dust, including pre-grinding, drying, conditioning with binder, densifying, cooling, screening, and packaging steps in accordance with an embodiment of the present invention.

FIG. 17 illustrates a sectional view of an exemplary pelletizing line showing a ring-die or flat-die pellet mill, conditioning chamber, and cooling system for forming discrete, cohesive cotton-waste pellets in accordance with an embodiment of the present invention.

FIG. 18 illustrates a perspective view of an exemplary pelletized cotton waste, showing uniform cylindrical pellets comprising compacted fibers bound with a natural or synthetic binder in accordance with an embodiment of the present invention.

FIG. 19 is a schematic diagram illustrating an exemplary compounding of pelletized cotton waste with a thermoplastic polymer and bonding agent in a twin-screw extruder, with an optional odor-neutralizing additive introduced through a secondary feeder in accordance with an embodiment of the present invention.

FIG. 20 illustrates a flowchart showing a process for producing a reinforced thermoplastic composite from pelletized cotton waste, including pellet manufacture, compounding, extrusion, pelletizing or filament formation, and optional 3D-printing utilization in accordance with an embodiment of the present invention.

The illustrated embodiments are merely examples and are not intended to limit the disclosure. The schematics are drawn to illustrate features and concepts and are not necessarily drawn to scale.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented, and the needs of a particular application may yield multiple alternatives and suitable approaches to implement the functionality of any detail described herein. Therefore, any approach may extend beyond certain implementation choices in the following embodiments.

Methods of the present invention may be implemented by performing or completing, executing manually, automatically, or a combination thereof, selected steps or tasks. The term “method” refers to manners, means, techniques, and procedures for accomplishing a given task, including, but not limited to, those manners, means, techniques, and procedures either known to or readily developed from known manners, means, techniques, and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

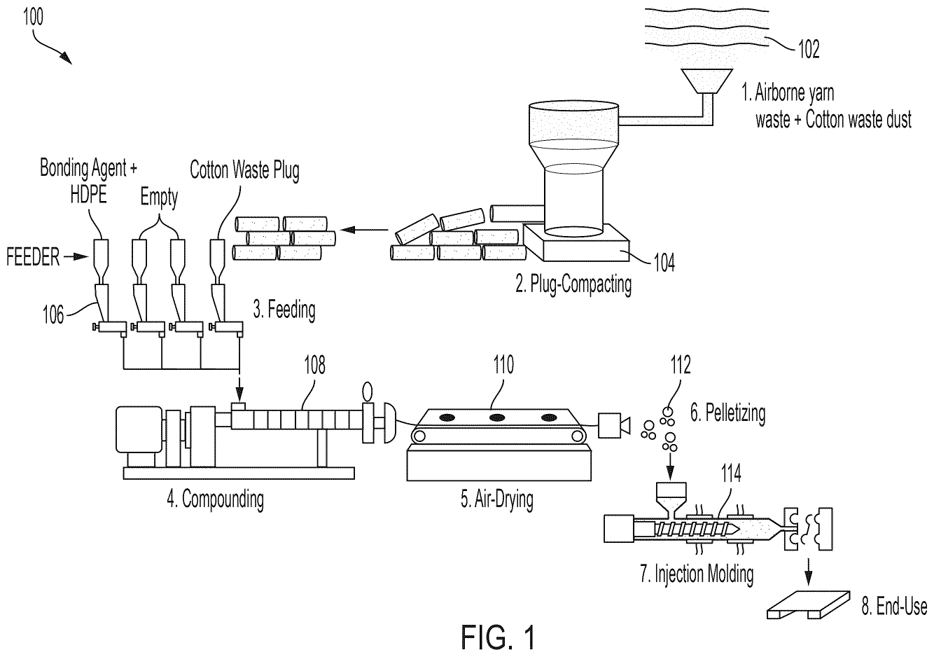

FIG. 1 illustrates a system 100 for forming a reinforced composite material in accordance with an embodiment of the present invention. The system 100 comprises a collection module 102, an apparatus 104, a feeding module 106, a compounding module 108, a drying module 110, a pelletizing module 112, and an injection molding module 114.

The collection module 102 collects an airborne yarn waste or cotton waste dust (waste/dust) from various sources, including fabrication and recycling processes. The cotton waste dust and the airborne yarn waste are pre-consumer cotton waste materials used in creating cotton waste plugs. The cotton waste dust, a fine byproduct from combing, is collected via filtration and reused in yarn production, while the airborne yarn waste, consisting of larger fiber clusters and lint from the knitting/weaving process, is captured through air filtration or cleaning. Both are vital for recycling and sustainable textile production, with distinct compositions and collection methods.

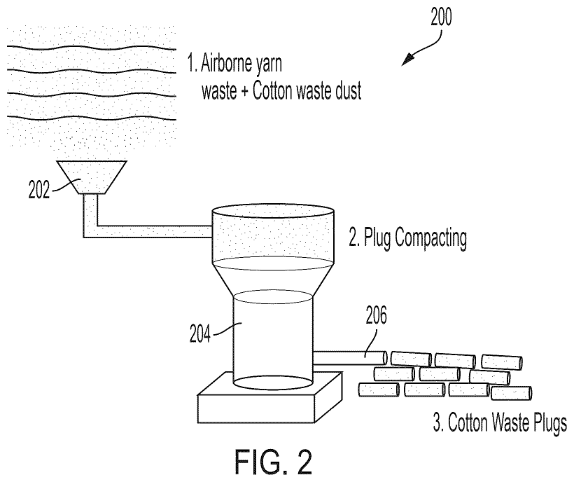

The apparatus 104 receives the airborne yarn waste or the cotton waste dust from the collection module 102. The apparatus 104 is configured to compact or compress the received airborne yarn waste or the cotton waste dust to a cotton waste plug. The functionality and structure of the apparatus 104 is discussed in detail in FIG. 2. The apparatus 104 addresses a critical need in the textile industry by providing a method to recycle waste materials.

The feeding module 106 receives the compacted or compressed cotton waste plug from the apparatus 104. The feeding module 106 may include one or more feeding units, configured to receive a thermoplastic polymer and a bonding agent.

The compounding module 108 receives the compacted or compressed cotton waste plug, the thermoplastic polymer and the bonding agent from the feeding module 106 to form a reinforced composite material or a blended composition. The compounding module 108 may include an extruder to form a strand-like structure of the blended composition which is further fed to the drying module 110.

The drying module 110 receives the strand-like structure or string of the blended composition directly from the compounding module 108 and performs a thorough drying operation. The drying module 110 ensures the removal of excess moisture from the material, which is essential for maintaining the quality, stability, and performance of the composition in subsequent manufacturing stages.

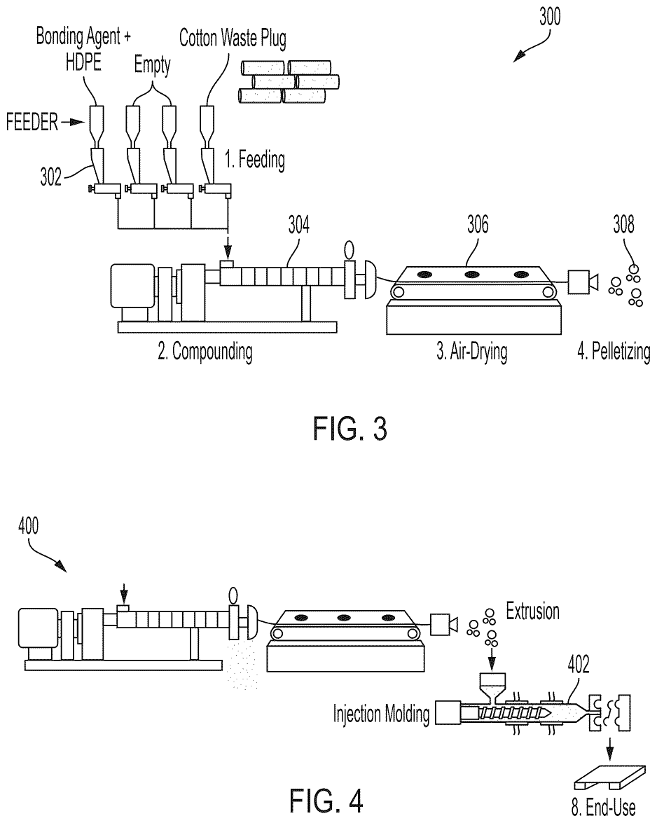

The pelletizing module 112 receives the dried strands or strings of the blended composition from the drying module 110 and cuts the dried strands or strings into pellets. The feeding module 106, the compounding module 108, the drying module 110 and the pelletizing module 112 are discussed in detail in FIG. 3.

The injection molding module 114 is injection molded into an end or a finished product. The end or finished product is a structural product used for transport and storage applications. The injection molding module 114 is discussed in detail in FIG. 4. The system 100 is designed to efficiently manufacture high-performance, durable composites suitable for various industrial applications.

FIG. 2 illustrates an apparatus 200 for manufacturing a cotton waste plug in accordance with an embodiment of the present invention. The apparatus 200 comprises an input source unit 202, a plunger unit 204, and an output unit 206.

The input source unit 202 is designed with a funnel shape, allowing it to efficiently receive airborne yarn waste or cotton waste dust from various sources, including fabrication and recycling processes or from the collection module (discussed in FIG. 1). This design ensures that the airborne yarn waste or the cotton waste dust is collected effectively, minimizing waste and maximizing the input material for processing.

The input source unit 202 may include a cabinet (not shown) to collect the airborne yarn waste or the cotton waste dust, which serves as a central processing chamber. The input source unit 202 or the cabinet is equipped with a vacuum pump that creates a negative pressure environment or suction force. This suction force is crucial for attracting and retaining the airborne yarn waste within the apparatus 200, ensuring that the material is properly contained and prepared for further processing.

The input source unit 202 may comprise a de-lumper unit (lump breaker) to break the airborne yarn waste or the cotton waste dust into smaller, uniform pieces to facilitate consistent feeding. The de-lumper unit may be connected at the input or the output end of the input source unit 202.

Once the cabinet is full, the airborne yarn waste or the cotton waste dust is directed to the plunger unit 204. The plunger unit 204 is responsible for compacting or compressing the airborne yarn waste at 100 PSI into a densified or compressed cotton waste plug. The plunger unit 204 may utilize at least one mechanical pressing, hydraulic compression, extrusion-based densification, thermal bonding, or chemical binding agents to apply the necessary pressure for compacting or compressing the airborne yarn waste or the cotton waste dust into a compressed cotton waste plug. The plunger unit 204 may be a linear plunger. Alternatively, the plunger unit 204 is a rotary plunger. The plunger unit 204 comprises at least one screw type, hydraulic type, piston type, and/or roller type. This process is essential for converting the loose airborne yarn waste into a more manageable and usable product.

The cotton waste plug comprises at least one of wool, flax, hemp, jute, polyester, nylon, or other natural or synthetic textile fibers obtained from pre-consumer apparel waste.

In one example, a humidity level of the cotton waste plug is less than 10%.

The output unit 206 is configured to output the densified cotton waste plug from the apparatus 200. The output unit 206 is equipped with a shaping die responsible for the shape of the densified cotton waste plug.

Further, the length of the shaping die decides the length of the cotton waste plug leaving the output unit 206. The length of the shaping die may cause a breaking line over the output at a certain length due to gravity applying over the output.

In one example, the shape of the densified cotton waste plug is cylindrical.

In another example, the shape of the densified cotton waste plug is square or rectangular.

The densified cotton waste plug may form into various shapes depending on the shape of the shaping die.

As the densified cotton waste plug exits the output unit 206, gravity breaks the densified cotton waste plug apart at a level where the gravity overcomes the weight to create the plug. The plug could be made shorter by increasing the height of the cabinet or lowering the exit tube.

The densified cotton waste plug offers improved transportability and storability compared to conventional fragile cotton sheets due to its enhanced density.

Alternatively, the output unit 206 may comprise a cutting unit or a mechanical cutter for breaking the output or the compacted blended composition.

The term “cotton waste plug”, “the plug” or “densified cotton waste plug” is used interchangeably throughout the specification and refer to the same entity and meaning. It conventionally refers to the processed product of airborne yarn waste but may refer to an unprocessed version of the collected airborne yarn waste.

FIG. 3 illustrates sub-modules of a system 300 for forming a reinforced composite material in accordance with an embodiment of the present invention. The system 300 includes a feeding module 302, a compounding module 304, a drying module 306, and a pelletizing module 308.

The feeding module 302 receives the compacted or compressed cotton waste plug from the apparatus (discussed in detail in FIG. 2). The feeding module 302 may include one or more feeding units, configured to receive a thermoplastic polymer, a bonding agent and the cotton waste plug. The feeding module 302 is designed to facilitate the integration of various materials necessary for creating a blended composition or the reinforced composite material.

For example, the first feeding unit 302-1 is configured to receive a thermoplastic polymer, which serves as the matrix material in the blended composition. The second feeding unit 302-2 is designated for the bonding agent, which enhances the adhesion between the polymer and the cotton waste plug. Additionally, the third feeding unit 302-3 is intended for delayed feeding and is currently shown as empty, indicating that the third feeding unit 302-3 may be used for future material inputs or adjustments in the process. The fourth feeding unit 302-4 is specifically tasked with receiving the cotton waste plug either directly or from the apparatus (discussed in FIG. 2), ensuring that this key component is efficiently integrated into the blended composition formulation. In one scenario, the fourth feeding unit 302-4 may receive the cotton waste plug from the apparatus either through a direct connection or via a conveyor belt, facilitating efficient material transfer into the composite formation process. The cotton waste plugs are introduced at a controlled rate via the fourth feeding unit 302-4. This structured approach within the feeding module 302 optimizes material handling and preparation, ultimately contributing to the production of high-quality reinforced composites.

In one example, the fourth feeding unit 302-4 may include a de-lumper unit or lump breaker to break the cotton waste plugs into small uniform pieces. The small uniform pieces of cotton waste facilitate consistent feeding.

In another example, the first and second feeding units (302-1, 302-2) may also include a de-lumper unit or lump breaker to break the thermoplastic polymer and the bonding agent into small uniform pieces.

The de-lumper is connected at an input end of the feeding units (302-1, 302-2, 302-4). In an alternate embodiment of the present invention, the de-lumper is connected at an output end of the feeding units (302-1, 302-2, 302-4).

The feeding module 302 may include a chamber module (not shown). The chamber module further comprises one or more chamber units for storing the thermoplastic polymer, the bonding agent and the cotton waste plug.

The compounding module 304 receives the compacted or compressed cotton waste plug, the thermoplastic polymer and the bonding agent from the feeding module 302 to form a reinforced composite material or a blended composition. The compounding module 304 includes a heating unit (not shown). The heating unit may comprise a feed zone, melting zone, and/or melt-pumping zone. The feed zone receives the small uniform pieces of the cotton waste plug or the airborne yarn waste, the thermoplastic polymer, and the bonding agent. The melting zone may include a heater for heating the thermoplastic polymer to a temperature sufficient to soften or melt the polymer.

The melt-pumping zone of the heating unit is utilized for pumping or forcing the cotton waste plug or the airborne yarn waste, the bonding agent and the thermoplastic polymer in a forward direction or towards the drying module 306. The heating unit facilitates the controlled blending of the melted thermoplastic polymer, the bonding agent with the cotton waste plug or the airborne yarn waste to form a blended composition or a reinforced composite material. The heating unit facilitates the uniform dispersion of the small uniform cotton waste plug or the airborne yarn waste within the thermoplastic polymer matrix. The heating unit may utilize a screw-type compactor which is of a low-shear screw design to prevent degradation or burning of the fibers during the blending process.

Alternatively, the airborne yarn waste or cotton waste plug is blended with the thermoplastic polymer and the bonding agent in a melt compounding process utilizing at least one of a twin-screw extruder, continuous mixer, or batch mixer to ensure controlled blending. In one example, the cotton waste dust is directly fed into the polymer melt, while in other cases, the cotton waste plug itself is introduced into the melt and broken down during processing.

The heating unit may comprise a heater and/or a temperature sensor. The temperature sensor monitors real-time temperature to aid the heater or the heating unit in maintaining the sufficient temperature required for the melting of the thermoplastic polymer. The heating unit may perform extrusion of the blended composition and force the blended composition towards an output unit of the compounding module 304.

The output unit outputs a strand-like structure or string of the blended composition. The compounding module 304 may include an extruder to form a strand-like structure or a string of the blended composition which is further fed to the drying module 306.

The drying module 306 receives the strand-like structure or the string of the blended composition. The strands-like structure or string of the extruded blended composition is introduced into a water bath or A.C.-enclosed conveyor belt to solidify (cool and dry without the water bath) while retaining residual heat to evaporate surface moisture. The drying module 306 ensures the removal of excess moisture from the material, which is essential for maintaining the quality, stability, and performance of the composition in subsequent manufacturing stages. The extruded blended composition is in continuous form or pelletized using a shaping die. The cooled string may be further pelletized for feeding into injection molding applications or may be spooled to form a roll for feeding into a 3-D printer for B2C applications.

The pelletizing module 308 is a vital component of the composite material production system, responsible for transforming dried strands or strings of blended composition received from the drying module 306. Once the blended composition has undergone drying to remove moisture, the composition is presented in the form of elongated strands. The pelletizing module 308 then employs an extrusion process to cut these dried strands into uniform pellets. This process not only standardizes the size and shape of the pellets but also ensures that they are suitable for subsequent processing stages, particularly injection molding, as elaborated in FIG. 4. The extrusion technique used in the pelletizing module allows for efficient handling and processing of the material, facilitating its conversion into a form that can be easily transported and utilized in manufacturing. By producing consistent pellets, pelletizing module 308 enhances the overall efficiency and quality of the composite material production process, ensuring that the final products exhibit desirable properties and performance characteristics. This step is crucial in preparing the blended composition for effective integration into various applications across multiple industries.

In one of the embodiments, the cotton waste plug or collected airborne yarn waste may be introduced through a side feeder into chamber 4 or so of the 10-chamber twin-screw heating process, allowing the thermoplastic polymer and bonding agent mixture to fully homogenize before encountering the fibers. By positioning the plug input point downstream from the thermoplastic polymer and bonding agent feeders, the system 300 ensures that the polymer blend has sufficient time to melt and mix thoroughly before interacting with the yarn or cotton waste, promoting uniform dispersion and enhancing fiber-matrix adhesion in the final reinforced composite material. Other feeding chambers are possible in order to allow the thermoplastic polymer and bonding agent mixture to fully homogenize before encountering the fibers.

FIG. 4 illustrates an injection molding module 402 of a system 400 in accordance with an embodiment of the present invention. The injection molding module 402 is designed to receive pellets produced by the pelletizing module, which is discussed in detail in FIG. 3. Once the pellets are delivered to the injection molding module 402, they undergo a transformation process where they are heated and injected into molds to create finished products or end products. The injection molding process allows for precise control over the shape and characteristics of the finished product, ensuring that it meets specific design and performance criteria. The injection molding module 402 not only enhances the efficiency of production but also enables the creation of complex geometries and structures that are essential in various applications across different industries. By effectively utilizing the pellets derived from the preceding stages of production, the injection molding module 402 plays a crucial role in turning raw materials into high-quality composite products ready for market use. The pellets may be molded into a variety of finished products, including but not limited to logistics pallets, hangers, construction materials, automotive components, and eco-friendly consumer goods.

By utilizing cotton waste in this manner, the present invention not only reduces textile waste but also enhances the mechanical properties of thermoplastic composites, contributing to more sustainable and high-performance materials for a range of industrial applications.

The compacted shape and size of the blended composition or the reinforced composite material as an output from the injection molding module 402 is due to the structure of a shaping die in the injection molding module 402. The shape of the shaping die decides the output shape of the finished product. The shape of the output may be cylindrical, rectangular, square, or other known shapes.

Further, the length of the shaping die decides the length of the finished product leaving the injection molding module 402. The length of the shaping die may cause a breaking line over the output at a certain length due to gravity applying over the output.

Alternatively, the injection molding module 402 may comprise a cutting unit or a mechanical cutter for breaking the output or the compacted blended composition.

The various materials involved in the formation of the blended composition. The composition includes (a) the airborne yarn waste, (b) the bonding agent, (c) a thermoplastic polymer, and (d) the final reinforced composite material, also referred to as the blended composition throughout this specification. The blended composition is formed by incorporating airborne yarn waste, derived from the cotton waste plug, into a thermoplastic polymer matrix, including the bonding agent, creating the final reinforced composite material with enhanced bio-mechanical properties.

The cotton waste plug serves as the primary source of airborne yarn waste, which is compounded with the thermoplastic polymer through a melting compounding process. This process ensures a uniform distribution of fibers within the polymer matrix, leading to a reinforced composite material with superior tensile strength, impact resistance, and durability. Once blended, the reinforced composite material undergoes further processing, such as injection molding, compression molding, or extrusion molding, to produce finished products.

In one exemplary embodiment, the blended composition consists of 12% the airborne yarn waste and 88% thermoplastic polymer, specifically High-Density Polyethylene (HDPE) (other chemical agents). This composition has demonstrated a 22% improvement in tensile strength compared to non-reinforced thermoplastic materials. In other embodiments, the airborne yarn waste content in the blended composition ranges from 12% to 30%, while the thermoplastic polymer content ranges from 70% to 88%, allowing for flexibility in material properties depending on the intended application.

The thermoplastic polymer used in the blended composition can include one or more of polypropylene (PP), polyethylene terephthalate (PET), low-density polyethylene (LDPE), polycarbonate (PC), acrylonitrile butadiene styrene (ABS), polylactic acid (PLA), or polyamide (PA), providing versatility in a material selection based on application-specific requirements.

The bonding agent, such as Orevac or any maleic anhydride, is mixed with high-density polyethylene (HDPE) at a typical ratio of 92% HDPE and 8% bonding agent to create a compatible polymer blend, which is then combined with cotton waste plugs or collected airborne yarn waste to produce a reinforced composite material with improved mechanical properties and fiber-matrix adhesion.

Post-consumer textile waste presents greater challenges due to the presence of dyes, finishes, and blended fibers. One potential solution involves cryogenic milling, where worn or discarded cotton garments are frozen and pulverized into a fine powder. This powder, although no longer suitable for textile applications, can be compounded with high-density polyethylene (HDPE) to create reinforced composites. This post-consumer approach not only diverts complex waste from landfills but also adds mechanical strength to the HDPE matrix, offering a second life to discarded textiles in durable, non-textile applications.

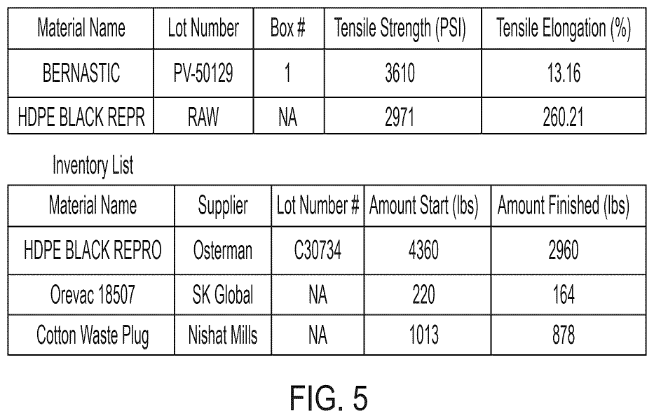

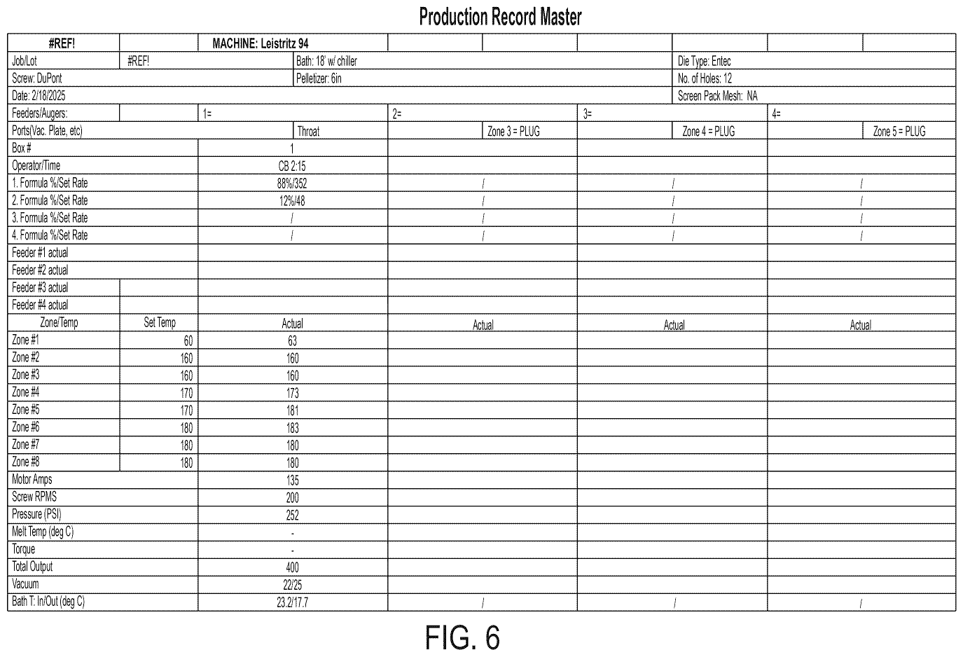

FIGS. 5 and 6 illustrate test results of the final reinforced composite after pelletizing and before injection molding in accordance with an embodiment of the present invention. In the present invention, the reinforced composite material (BERNASTIC) is manufactured by collecting airborne yarn waste and, or cotton waste dust to be compounded with a thermoplastic polymer and bonding agent. The thermoplastic polymers are High-Density Polyethylene, Black, and Reprocessed (HDPE BLACK REPRO). The bonding agent (maleic annhydride) is Orevac 18507. The amount of cotton waste plugs, HDPE BLACK REPRO, and Orevac being mixed is 1013, 4360, and 220, respectively. As a result, the tensile strength of the reinforced composite material is 3610 PSI (22% improvement) and tensile elongation improvement is 13.16%.

To further enhance the mechanical properties and functional performance of HDPE composites, reinforcement can extend beyond cotton waste powder to include rigid, mineral-based fillers such as crushed porcelain, quartz, and feldspar. These ceramic and silicate materials introduce significant hardness, abrasion resistance, and dimensional stability to the composite, complementing the fibrous reinforcement provided by the cotton waste. Crushed porcelain and quartz, with their high compressive strength and thermal resistance, improve stiffness and impact resistance, while feldspar contributes to the composite's toughness and thermal stability

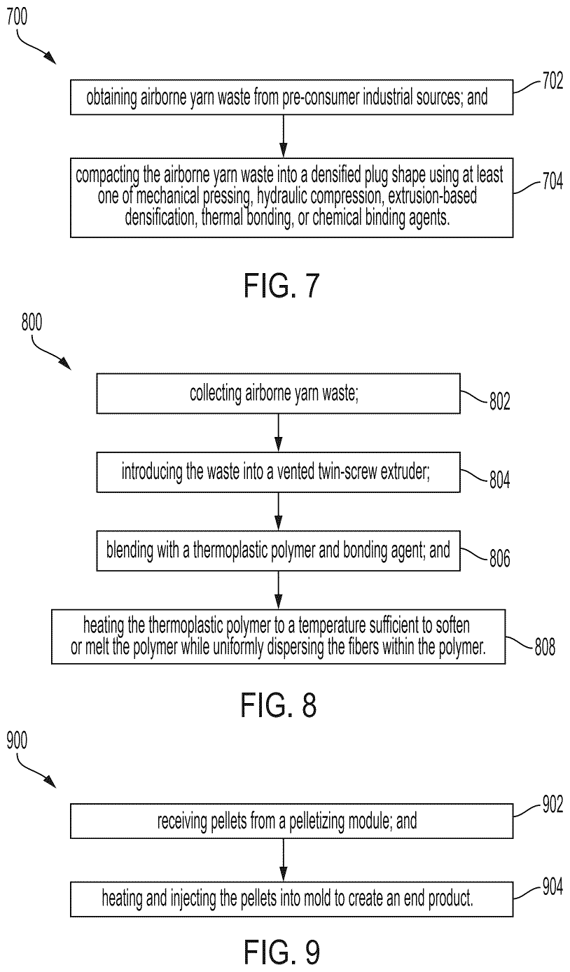

FIG. 7 illustrates a method 700 flow diagram for manufacturing a cotton waste plug in accordance with an embodiment of the present invention. The method 700 comprises the steps of a) obtaining airborne yarn waste from pre-consumer industrial sources 702; and b) compacting the airborne yarn waste into a densified plug shape using at least one of mechanical pressing, hydraulic compression, extrusion-based densification, thermal bonding, or chemical binding agents 704.

The collection of airborne yarn waste is essential for reducing environmental impact by reusing materials that would otherwise be discarded.

This compaction process results in the densified plug shape that is not only compact but also durable, making it suitable for efficient storage and transportation. The enhanced density of the plug reduces storage space requirements and facilitates handling, contributing to cost savings and environmental benefits.

FIG. 8 illustrates a method 800 flow diagram for forming a blended composition in accordance with an embodiment of the present invention. The method 800 comprises the steps of: a) collecting airborne yarn waste 802; b) introducing the waste into a vented twin-screw extruder 804; c) blending with a thermoplastic polymer and bonding agent 806; and d) heating the thermoplastic polymer to a temperature sufficient to soften or melt the polymer while uniformly dispersing the fibers within the polymer 808.

Further, extruding the blended composition into a continuous form or pelletizing the material using a strand-cut die system. In other embodiments, a spooling version of the extruded strands may be possible that will allow it to work with 3D printers. The strands emerging from the die may be introduced into a water bath to solidify while retaining residual heat to evaporate surface moisture before cutting into pellets and ensuring the pelletized material is dried before injection molding, using a customer-equipped dryer system to remove any moisture absorbed from the atmosphere during storage or transport. Further, the dried, pelletized material is injection molded into an end product, and the end product is a structural product used for transport and storage applications.

The reinforced composite material involves using a specific thermoplastic polymer, such as polypropylene or polyethylene, which is heated to a suitable temperature to ensure optimal softening and melting while uniformly dispersing the cotton waste fibers or the airborne yarn waste fibers within the polymer matrix. This enhances the mechanical properties of the composite by ensuring compatibility between the polymer and the fibers.

Further, the method focuses on improving the dispersion of cotton waste fibers or airborne yarn waste fibers within the thermoplastic polymer matrix. This is achieved by incorporating a mixing aid during the blending process. The low-shear screw design of the extruder is further optimized to minimize fiber breakage, ensuring a uniform distribution of fibers throughout the composite material.

The extrusion process is customized to produce a continuous form with specific dimensions, such as cylindrical rolls, which can be directly used in various applications without the need for pelletizing. This approach reduces processing steps and enhances the efficiency of the manufacturing process.

The method may use advanced drying techniques during the pelletizing process. Instead of a water bath, a controlled air drying system is employed to solidify the strands while minimizing moisture absorption. This ensures that the pellets have a lower moisture content, which is crucial for maintaining the quality and consistency of the composite material during injection molding.

The strands may enter a conveyor belt that is enclosed and air conditioned in order to solidify the strands while minimizing moisture absorption.

The injection molding process specializes in producing complex geometries or thin-walled parts. This is achieved by using high-pressure injection molding machines and optimizing the mold design to ensure uniform filling and cooling of the composite material. The result is a finished product with enhanced structural integrity and aesthetic appeal.

The present invention involves combining cotton waste plugs with other reinforcement materials, such as carbon fibers or glass fibers, to produce the reinforced composite material. This approach allows for tailoring the mechanical properties of the composite material to meet specific application requirements, such as improved strength, stiffness, or impact resistance. The reinforcement is achieved during the blending process, ensuring a uniform distribution of all reinforcement materials within the thermoplastic polymer matrix.

While not illustrated, in one embodiment, the blending process for incorporating the cotton waste plug into the thermoplastic polymer, such as HDPE, is designed to accommodate a higher cotton waste content, increasing from 12% to up to 30%. This process involves the low-shear screw design within the compounding extruder to minimize heat buildup and prevent thermal degradation or “burning” of the cotton fibers. Due to the low bulk density of cotton waste, a side-feeding system is utilized to ensure consistent material input. An Acrison feeder, equipped with dual agitators in the hopper, may be implemented to improve feeding efficiency and maintain a steady material flow. Additionally, the de-lumper (lump breaker) may be used to break down larger fiber clusters, promoting better dispersion during compounding.

A vented compounding extruder, such as a Farrel Continuous Mixer or a parallel twin-screw extruder (e.g., Leistritz, Coperion), may be employed to facilitate fiber dispersion while utilizing vacuum venting to remove residual moisture. The pelletizing process is performed using a strand-cut die system, which allows the extruded strands to briefly contact water or A.C.-enclosed conveyor belt before being cut into pellets, leveraging residual heat to promote surface water evaporation. To further control moisture absorption, downstream processing may include a drying system to remove any atmospheric moisture from the pellets before injection molding or extrusion.

Increasing the airborne yarn waste content in the composite material by up to 30% offers potential benefits, including reducing dependency on virgin (or recycled) HDPE, lowering production costs, and improving the sustainability of the final product. The increased fiber content may also enhance mechanical properties, such as tensile strength, impact resistance, and thermal and acoustic insulation, making the composite material suitable for a range of applications, including logistics pallets, hangers, construction materials, automotive components, and eco-friendly consumer goods.

FIG. 9 illustrates a method 900 flow diagram for injection molding a blended composition to form an end product in accordance with an embodiment of the present invention. The method comprises the steps of a) receiving pellets from a pelletizing module 902 and; b) heating and injecting the pellets into mold to create an end product 904.

In step 902, the blended composition is processed into pellet form for ease of handling and uniformity in material properties.

In step 904, the molten material is subsequently injected into a mold under controlled pressure and temperature conditions. Inside the mold, the material takes the shape of the cavity, forming the desired configuration of the end product. The molded product is then allowed to cool and solidify within the mold, ensuring dimensional stability and structural integrity. Finally, the solidified product is ejected from the mold, completing the process. This method 900 ensures efficient transformation of blended compositions into high-quality finished products with precise shapes and properties suitable for various industrial applications.

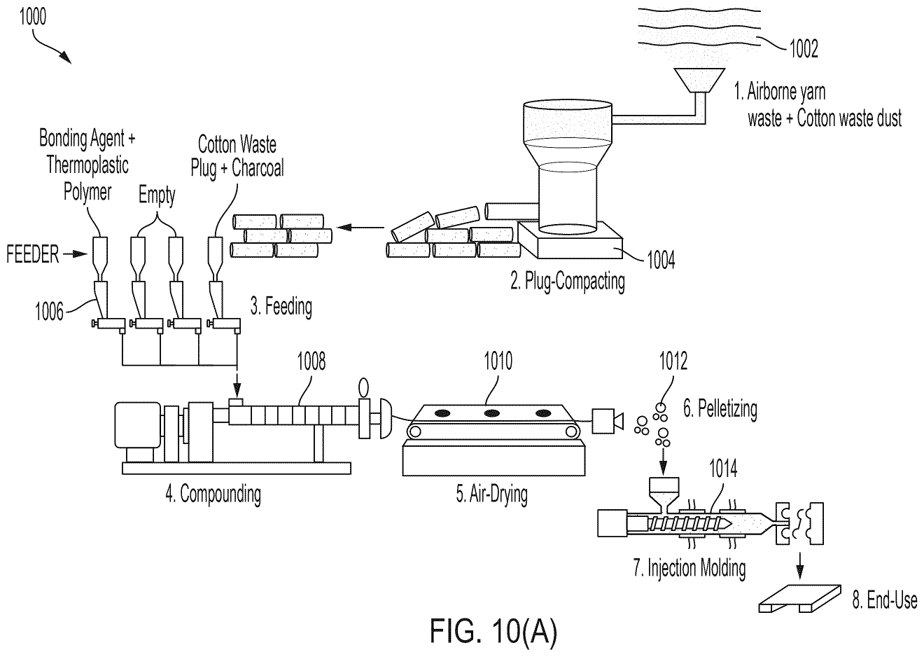

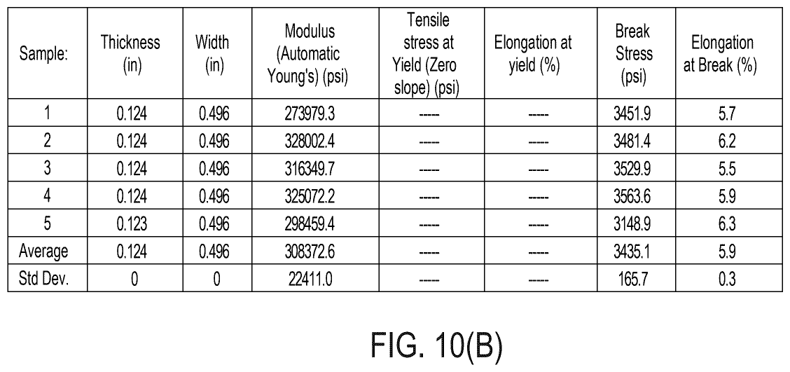

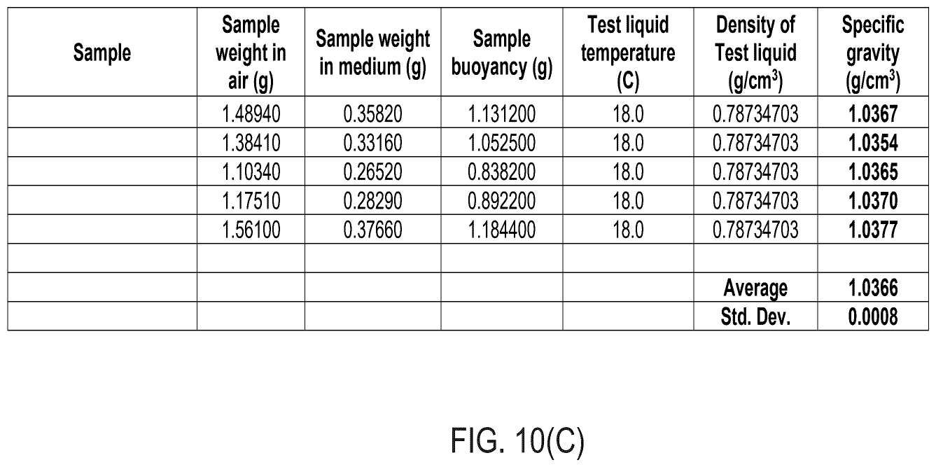

FIG. 10 (A) illustrates a system 1000 for forming a reinforced composite material in accordance with an embodiment of the present invention. The system 1000 includes a collection module 1002, an apparatus 1004, a feeding module 1006, a compounding module 1008, a drying module 1010, a pelletizing module 1012, and an injection molding module 1014.

The collection module 1002 is configured to collect airborne yarn waste and/or cotton waste dust (hereinafter referred to as waste/dust) from a variety of sources, such as fabrication and recycling processes. The collected collect airborne yarn waste and/or cotton waste dust is then conveyed to the apparatus 1004, which is specifically designed to densify and subsequently compact or compress the received airborne yarn waste or cotton waste dust into a cotton waste plug. The densification and compaction processes within the apparatus 1004 is already discussed in FIG. 1.

Following compaction, the cotton waste plug is transferred to the feeding module 1006. The feeding module 1006 is equipped to receive the compacted or compressed cotton waste plug from the apparatus 1004 and may comprise one or more feeding units configured to receive materials such as the airborne yarn waste or cotton waste dust in plug form, a bonding agent, a thermoplastic polymer, and a charcoal additive. These feeding units may be gravimetric or volumetric, allowing for precise and consistent delivery of each component. In one example, the charcoal additive is provided and fed in the form of pellets, each pellet having a controlled size and shape to facilitate uniform distribution and integration within the composite material during compounding.

The type of the bonding agent and the thermoplastic polymer used during the process is discussed in detail in FIG. 1 and FIG. 4.

The charcoal additive, which is a key feature of the invention, comprises at least one of an activated charcoal, biochar, or carbon black derived from biomass or recycled organic material. The charcoal additive is provided in a particulate form selected from powder, granules, or micronized particles suitable for uniform mixing during compounding. Further, the charcoal additive is present in an amount ranging from 0.5% to about 2.5% by weight of the total composition and has a particle size distribution between 10 microns and 150 microns to promote dispersion during melt compounding. The charcoal additive provides at least one of antimicrobial or odor-absorbing properties to the reinforced composite material. The charcoal additive is derived from pyrolyzed agricultural waste, including but not limited to coconut shells, rice husks, bamboo, or walnut shells. The pyrolyzed charcoal is further activated via steam or chemical treatment to increase surface area and porosity. In addition to its antimicrobial and odor-absorbing properties, the presence of the charcoal additive improves the thermal conductivity and/or flame resistance of the final reinforced composite. For improved compatibility with the thermoplastic matrix, the charcoal additive is surface-treated with a compatibilizer or dispersing agent.

In one embodiment, the charcoal additive is blended with the cotton yarn waste in plug form, or in other forms, and then fed into the compounding steps. In other embodiments, the charcoal additive is fed directly into the compounding steps, in a controlled manner to ensure dispersion. In other embodiments, the charcoal additive is directly fed in pellet form.

The feeding module 1006 may include a first feeding unit configured to receive the thermoplastic polymer and the bonding agent, a second and third feeding units are empty, and a fourth feeding unit for the airborne yarn waste or cotton waste dust in plug form along with the charcoal additive.

The compounding module 1008 receives the compacted or compressed cotton waste plug, the thermoplastic polymer, the bonding agent and the charcoal additive from the feeding module 1006 to form a reinforced composite material or a blended composition. The compounding module 1008 comprises at least one of a twin-screw extruder, continuous mixer, or batch mixer, and the components are introduced through at least one or more feed inlets arranged to ensure even mixing.

The compounding module 1008 is discussed in detail in FIG. 3 description, therefore, to avoid repetition it is not described here. The functionality of the compounding module 1008, remain the same as described in FIG. 3.

The drying module 1010 receives the strand-like structure or string of the blended composition directly from the compounding module 1008 and performs a thorough drying operation. In one example, the compounded composition is extruded into a continuous filament or string form suitable for spooling and use in three-dimensional printing processes.

The pelletizing module 1012 receives the dried strands or strings of the blended composition from the drying module 1010 and cuts the dried strands or strings into pellets. The pellets are suitable for downstream molding, forming, or additive manufacturing. The compounded material is pelletized by extruding the blended composition through a die, cooling the extrudate in a water bath, and cutting it into pellets. The pelletized material is then dried to remove residual moisture before any molding or forming operation. The dried pelletized material is subsequently molded into a structural article by at least one of injection molding, compression molding, or extrusion molding.

In another embodiment to the sequential drying module 1010 and pelletizing module 1012, the system may incorporate an integrated underwater pelletizing (UWP) unit positioned downstream of the compounding module 1008. In this configuration, the compounded composition is extruded directly through a specialized die plate into a water chamber where high-speed rotating blades immediately cut the extruded material into uniform pellets. The presence of water in the cutting chamber serves a dual function: it cools the freshly cut pellets rapidly and simultaneously facilitates gentle conveyance away from the cutting zone. This process eliminates the need for the intermediate drying of strand-like extrudates and allows for more continuous, automated handling of the compounded material.

Once cut, the water-suspended pellets are conveyed through a fluid stream into a centrifugal drying chamber, which efficiently separates the water from the pellets using centrifugal force. This integrated drying system reduces moisture content to acceptable levels for downstream manufacturing processes, such as injection molding, compression molding, or extrusion molding. The compact nature of the UWP system streamlines the footprint of the entire production line and enhances process continuity, particularly in high-throughput environments. Additionally, the UWP system reduces handling of fragile or thermally sensitive materials by eliminating the need for manual transfer between modules.

In yet another embodiment, the drying module 1010 may still receive the strand-like structures or continuous filament extrudate directly from the compounding module 1008, especially when the compounded material is destined for applications such as filament-based additive manufacturing. In such a configuration, the drying operation is carefully tuned to preserve the structural integrity and dimensional consistency of the extruded filaments, which may subsequently be spooled for use in three-dimensional (3D) printing. Alternatively, the pelletizing module 1012 may be configured to receive the fully dried strands and cut them into discrete pellets suitable for conventional molding operations.

These alternative embodiments enable flexible implementation depending on the desired downstream process, material properties, and operational constraints. Whether the compounded composition is intended for pelletized feedstock in molding operations or continuous filament for additive manufacturing, the disclosed system accommodates diverse processing requirements through modular, integrable components, including but not limited to UWP-based and conventional air-drying and strand-cutting modules.

The injection molding module 1014 molds the dried pellets into an end or finished product. The resulting composite material includes uniformly dispersed fibers and charcoal additive, and exhibits improved structural strength, dimensional stability, thermal performance or conductivity, and/or flame resistance as compared to compositions without the charcoal additive.

Alternatively, the first feeding unit is used to receive the thermoplastic polymer, the second feeding unit receives the bonding agent, the third feeding unit receives the charcoal additive, and the fourth feeding unit receives the cotton waste plug.

Alternatively, the first feeding unit receives the bonding agent and thermoplastic polymer, the second feeding unit receives the charcoal additive, and the fourth feeding unit receives the cotton waste plug, with the third feeding unit remaining empty.

Alternatively, the first feeding unit receives the bonding agent and the thermoplastic polymer, and the fourth feeding unit receives the cotton waste plug pre-mixed with charcoal additive, with the second and the third feeding units remaining empty.

Alternatively, the first feeding unit receives the bonding agent and the thermoplastic polymer, the fourth feeding unit receives the cotton waste plug, with the second and third feeding units remaining empty. The charcoal additive is fed through a dedicated feeder, a fifth feeding unit, which is attached to the melt zone of the compounding module. Alternatively, the compressed plugs are introduced at a primary feed location, and the charcoal additive is introduced either simultaneously through a co-feeder or downstream into the mixing zone to promote homogeneous distribution.

Alternatively, the first feeding unit receives a pre-blended charcoal additive with the thermoplastic polymer, the second feeding unit receives the bonding agent, and the fourth feeding unit receives the cotton waste plug, with the third feeding unit remaining empty.

The functionality and structure of alternating embodiments as discussed above is same as what is explained in FIG. 10 (A), therefore not repeated here to avoid repetition. The only difference between the FIG. 10 (A) and FIG. 1 is the addition of charcoal additive to mitigate foul odors and enhance the tensile strength of the blended composition and using different feeders (as clearly explained above) to receive cotton waste plug, charcoal additive, bonding agent and thermoplastic polymer, respectively.

FIG. 10(B) and 10(C) illustrate the results of mechanical and physical property testing performed on the thermoplastic polymer blend containing 25% cotton. The Young's modulus of the end-product were evaluated and are summarized in FIG. 10 (B). This table includes measurements of thickness, width, modulus (Automatic Young's Modulus), break stress, and elongation at break for five tested samples, along with calculated average and standard deviation values. The results indicate consistent mechanical properties across the samples, with an average Young's modulus of 308,372.6 psi and an average break stress of 3,435.1 psi. Elongation at break was observed to be approximately 5.9% on average, demonstrating moderate ductility for the material. FIG. 10 (C) details the specific gravity and density determinations for the same blend, showing highly repeatable results with an average specific gravity of 1.0366 (g/cm³) and a standard deviation of only 0.0008. These findings highlight the end-product's uniformity and suitability for further mechanical and physical evaluation.

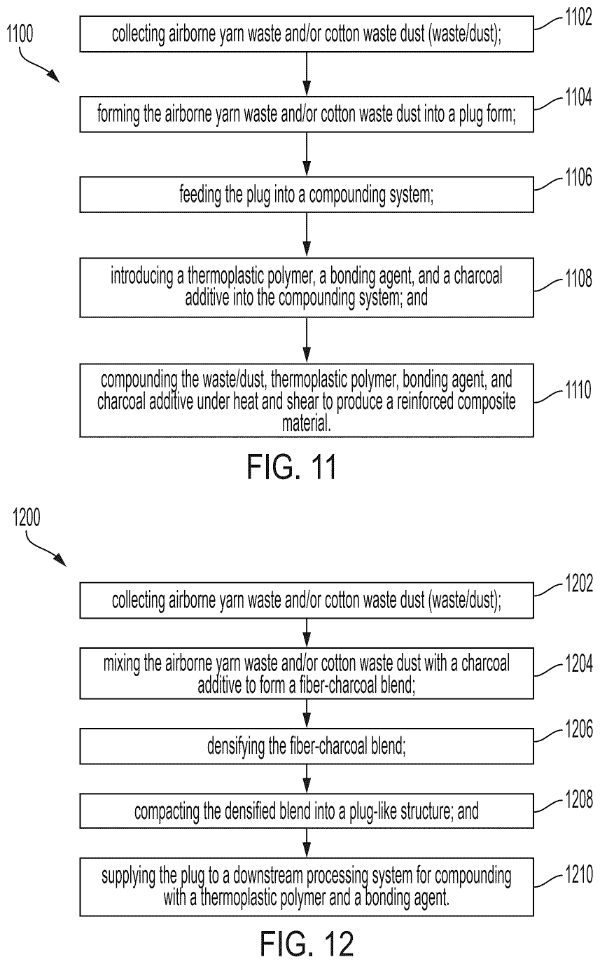

FIG. 11 illustrates a method 1100 for producing a reinforced composite material in accordance with an embodiment of the present invention. The method 1100 comprises a series of sequential steps designed to efficiently convert airborne yarn waste and/or cotton waste dust into a high-performance composite product. The method 1100 begins with the step of collecting 1102 airborne yarn waste and/or cotton waste dust (hereinafter referred to as waste/dust) from fabrication or recycling sources. This initial collection step 1102 ensures that even fine, airborne fibrous residues are effectively gathered for subsequent processing, thereby promoting sustainability and reducing environmental waste.

Following collection, the method 1100 proceeds to the step of forming 1104 the airborne yarn waste and/or cotton waste dust into a plug form. The forming step 1104 specifically includes densifying the collected waste/dust and compacting it into a plug using at least one of mechanical pressing, hydraulic compression, extrusion-based densification, thermal bonding, or chemical binding agents. This compaction process transforms the loose, low-density fibers into a manageable and uniform plug, facilitating accurate dosing and efficient feeding in downstream operations.

The next step involves feeding 1106 the plug into a compounding system. The compounding system may comprise at least one of a twin-screw extruder, a continuous mixer, or a batch mixer, with the plug introduced through one or more feed inlets arranged to ensure even mixing of all components. In parallel, the method 1100 includes introducing 1108 a thermoplastic polymer, a bonding agent, and a charcoal additive into the compounding system. The thermoplastic polymer may comprise at least one of high-density polyethylene (HDPE), polypropylene (PP), polyethylene terephthalate (PET), low-density polyethylene (LDPE), polycarbonate (PC), acrylonitrile butadiene styrene (ABS), polylactic acid (PLA), or polyamide (PA). The charcoal additive may be introduced into the compounding system by at least one of the following approaches: (a) pre-blending with the fiber plug, (b) independent feeding using a gravimetric or volumetric feeder, or (c) blending with the thermoplastic polymer prior to introduction. This flexibility in the introduction of the charcoal additive allows for optimal dispersion and compatibility within the composite matrix.

The method 1100 then advances to the compounding step 1110, wherein the airborne yarn waste and/or cotton waste dust, thermoplastic polymer, bonding agent, and charcoal additive are compounded under heat and shear to produce a reinforced composite material. The compounding system ensures thorough mixing and melting of the thermoplastic polymer, bonding agent, and uniformly disperses the fibers and charcoal additive throughout the matrix. The compounded material may then be pelletized by extruding the blended composition through a die, cooling the extrudate in a water bath, and cutting it into pellets. The pelletized material is further dried to remove residual moisture, ensuring optimal properties for subsequent molding or forming operations. The dried, pelletized material is then molded into a structural article by at least one of injection molding, compression molding, or extrusion molding.

Alternatively, the compounded composition may be extruded into a continuous string or filament and wound onto a spool for use in three-dimensional (3D) printing applications. This approach provides additional versatility, enabling the production of composite filaments suitable for additive manufacturing technologies.

The resulting composite material produced by method 1100 includes uniformly dispersed fibers and charcoal additive, and exhibits improved structural strength, dimensional stability, or thermal performance as compared to compositions without the charcoal additive. The charcoal additive, as incorporated in the method 1100, provides at least one of antimicrobial or odor-absorbing properties to the reinforced composite material. The charcoal additive is derived from pyrolyzed agricultural waste selected from at least one of coconut shells, rice husks, bamboo, or walnut shells. The pyrolyzed charcoal is further activated via steam or chemical treatment to increase its surface area and porosity, thereby enhancing its functional properties within the composite.

To promote optimal dispersion during melt compounding, the charcoal additive has a particle size distribution between 10 microns and 150 microns. Furthermore, the charcoal additive is surface-treated with a compatibilizer or dispersing agent to enhance bonding with the thermoplastic matrix. The presence of the charcoal additive in the composite material not only imparts antimicrobial and odor-absorbing properties but also improves the thermal conductivity or flame resistance of the final reinforced composite, thereby expanding its range of potential applications.

FIG. 12 illustrates a method 1200 for producing a charcoal-infused fiber plug for subsequent use in composite material manufacturing, in accordance with an embodiment of the present invention. The method 1200 is designed to efficiently integrate a charcoal additive into fibrous waste material, thereby creating a value-added intermediate suitable for downstream compounding with thermoplastic polymers and bonding agents.

The method 1200 begins with the step of collecting 1202 airborne yarn waste and/or cotton waste dust (hereinafter referred to as waste/dust) from sources such as textile fabrication, processing, or recycling operations. This initial collection step 1202 ensures the capture and recovery of fine, otherwise discarded fibrous residues, thus promoting sustainability and reducing environmental impact.

Following collection, the method advances to the step of mixing 1204 the airborne yarn waste and/or cotton waste dust with a charcoal additive to form a fiber-charcoal blend. The charcoal additive may comprise at least one of activated charcoal, biochar, or carbon black derived from pyrolyzed agricultural waste such as coconut shells, rice husks, bamboo, or walnut shells. The charcoal additive is preferably introduced in a finely divided form, such as powder, granules, or micronized particles, with a particle size distribution between 10 microns and 150 microns to ensure uniform blending with the fibrous material. The mixing step 1204 may be accomplished using mechanical mixers, blenders, or other suitable agitation equipment to achieve a homogeneous fiber-charcoal blend. The charcoal additive may be surface-treated with a compatibilizer or dispersing agent to enhance its compatibility with the fiber matrix and, ultimately, with the thermoplastic polymer in downstream processing.

Once a uniform fiber-charcoal blend has been achieved, the method proceeds to densifying 1206 the blend. The densification step 1206 may utilize at least one of mechanical pressing, hydraulic compression, extrusion-based densification, thermal bonding, or chemical binding agents to increase the bulk density of the fiber-charcoal blend. This step is critical for improving the handling characteristics of the blend, reducing its volume, and preparing it for efficient compaction.

Subsequently, the method includes compacting 1208 the densified fiber-charcoal blend into a plug-like structure. This compaction step 1208 transforms the densified blend into a uniform, manageable plug that can be easily handled, stored, and accurately dosed in subsequent processing steps. The plug-like structure ensures consistent material input for downstream compounding and enhances process control.

Finally, the method 1200 comprises supplying 1210 the charcoal-infused fiber plug to a downstream processing system. In this step, the plug is delivered to a compounding system where it will be further processed with a thermoplastic polymer and a bonding agent to produce a reinforced composite material. The integration of the charcoal additive at the plug formation stage ensures its uniform dispersion in the final composite, thereby imparting desirable properties such as antimicrobial activity, odor absorption, improved thermal conductivity, and enhanced flame resistance to the end product.

By following the steps of collecting 1202, mixing 1204, densifying 1206, compacting 1208, and supplying 1210, the method 1200 provides an efficient and scalable approach for producing a charcoal-infused fiber plug, optimizing both material utilization and the performance of subsequent composite materials.

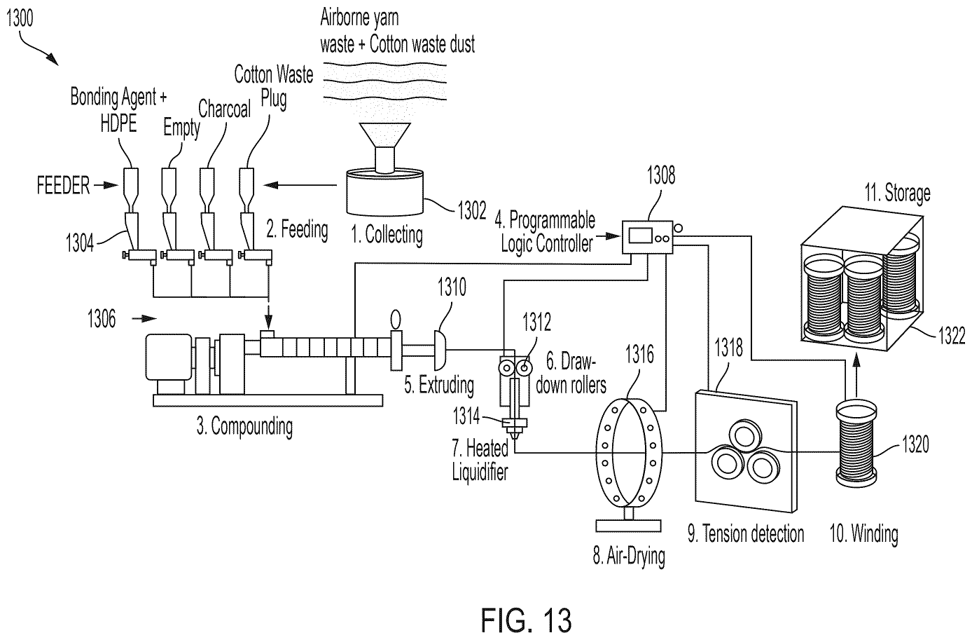

FIG. 13 illustrates a system 1300 for producing a reinforced composite filament in accordance with an embodiment of the present invention. The system 1300 comprises a collection module 1302, one or more feeders 1304, an extrusion line 1306, a programmable logic controller 1308, a temperature-controlled extrusion die 1310, a draw-down roller assembly 1312, a heated liquefier 1314, an air injection apparatus 1316, a tension detector 1318, a synchronized filament winder 1320, and a humidity-controlled storage chamber 1322.

The collection module 1302 is configured to collect airborne yarn waste and/or cotton waste dust (herein after referred to as the waste/dust) from a variety of sources, such as pre-consumer or industrial sources (generated during manufacturing processes), post-consumer source or household and retail sources, and agricultural and raw material handling sources (including cotton ginning factories). In one example, the collection module 1302 may employ suction fans or air jets to create air streams that capture the waste/dust from various machine components. The collection module 1302 may comprise of a collection chamber that collects the captured waste/dust via ducts, where the waste and dust are trapped in a filter or collection bag while clean air is released back into the environment.

The collected waste/dust is then fed to the extrusion line 1306 via one or more feeders 1304. The one or more feeders 1304 are configured to receive one or more materials for compounding. The one or more materials include at least one of the airborne yarn waste and/or cotton waste dust, a thermoplastic polymer, a bonding agent, or a charcoal additive. In an example, the one or more materials can be pre-mixed upstream or blended in situ within the extrusion line 1306. In one example, the one or more feeders 1304 are hoppers. The one or more feeders 1304 are mounted above a feed throat of the extrusion line 1306, located at a proximal end. The one or more feeders 1304 may be gravimetric or volumetric to allow accurate dosing, homogenous mixing, and continuous flow.

In one example, the one or more materials, including airborne yarn waste or cotton waste dust, a thermoplastic polymer, a bonding agent, or a charcoal additive can be fed to the one or more feeders 1304 in the form of pellets. Before feeding the pellets into the one or more feeders 1304, the pellets are cooled. The cooling of the pellets may be a result of underwater pelletization (UWP).

The one or more feeders 1304 are configured with a weight sensor for real-time weight monitoring in view of maintaining accurate blend ratios. Each material is stored in a separate hopper. The system 1300 comprises the programmable logic controller (PLC) 1308 for PLC-controlled dosing of the materials into the extrusion line 1306 with real-time weight monitoring of the materials. In one example, the cotton waste fibers or dust are present in the composition in an amount ranging from 15 wt. % to 35 wt. %.

In one example, the bonding agent is orevac.

The thermoplastic polymer comprises at least one of high-density polyethylene (HDPE), polypropylene (PP), polyethylene terephthalate (PET), low-density polyethylene (LDPE), polycarbonate (PC), acrylonitrile butadiene styrene (ABS), polylactic acid (PLA), or polyamide (PA).

The charcoal additive comprises at least one of activated charcoal, biochar, or carbon black derived from biomass or recycled organic matter. In an embodiment, the charcoal additive is present in the composition in an amount ranging from 0.5 wt. % to 1.5 wt. %. The charcoal additive present in the composition functions as both a deodorizing and tensile-strengthening agent. High surface area and microporosity of the charcoal additive contribute to the odor absorption while improving interfacial bonding with the polymer matrix. The addition of charcoal also enhances the filament's thermal stability and rigidity, making it suitable for load-bearing print applications.

In another example, the one or more feeders 1304 include a dual-feeder configuration for introducing distinct feedstock or materials into the extrusion line 1306. One of the one or more feeders 1304 is configured to supply HDPE from a first feeding unit 1304-1. The feeder 1304 that delivers a continuous and precise flow of HDPE material into the extrusion line 1306 is a gravimetric screw-based dosing mechanism. Another of the one or more feeders 1304 is positioned adjacent to the first feeding unit and supplies a fibrous particulate mixture comprising cotton waste dust and the charcoal additive. The feeder 1304 that delivers the particulate mixture into the extrusion line 1306 utilizes a gravimetric twin-screw or vibratory dosing mechanism capable of handling low-bulk density and irregularly shaped particulates. This dual-feeder is operably connected to a programmable logic controller 1308 configured to maintain a pre-determined blend ratio during continuous operation.

The HDPE, waste/dust, and charcoal additive enter the feed throat of the extrusion line 1306 for compounding to form a composite melt or a blended or reinforced composite material. The extrusion line 1306 is configured to process the composite material containing polymer, fiber waste/dust, and the charcoal additive. The extrusion line 1306 comprises a co-rotating twin-screw extruder. The extruder includes a barrel with multiple temperature-controlled zones and intermeshing screws that shear, melt and compound the blended materials. The screw design includes mixing and conveying sections to ensure uniform dispersion of the cotton waste fibers/dust and charcoal additives within the molten polymer melt or matrix. The temperature across the barrel zones is maintained in the range of 220° C. to 270° C., ensuring complete melting of HDPE and uniform distribution of the cotton and charcoal additives. The composite melt is conveyed towards the temperature-controlled extrusion die 1310 located at a distal end of the barrel for forming the composite melt into a continuous composite filament. The composite melt is kept homogenous and well-plasticized to prevent filament breakage.

The temperature-controlled extrusion die 1310 features integrated thermocouples and PID controllers that maintain the die temperature within ±3° C. of a setpoint, ensuring filament dimensional stability. The compounding occurs at a melt temperature of about 250° C. and a die temperature of about 240° C. The composite melt is extruded through the heated die 1310 under pressure to form the filament with a final diameter ranging from 1.8 to 1.95 mm. The extrusion die 1310 includes a circular orifice through which the composite melt is extruded. The die 1310 of varying opening sizes and circular orifices is allowed to be used. In one example, the die diameter is in the range of 1.5 mm to 2.5 mm. In another example, the die diameter is in the range of 1 mm to 2 mm. In yet another example, the die diameter is 2 mm.

Immediately downstream of the die 1310, the draw-down roller assembly 1312 is positioned to regulate filament tension and diameter. The draw-down roller assembly 1312 comprises motorized rollers with adjustable speed control and a feedback tension system for maintaining a constant filament cross-section during the draw-down. After exiting the die 1310, the filament is engaged by the rotating rollers that maintain filament tension and regulate speed. The draw-down roller assembly 1312 is synchronized with the extruder output to avoid stretching or compressing the filament.

The draw-down roller assembly 1312 is connected with the heated liquefier 1314. Upon entering the heated liquefier 1314, the filament is subjected to carefully regulated thermal conditions, raising its temperature above the glass transition point of the material. This process transforms the solid filament into a malleable, semi-liquid state suitable for extrusion. The heated liquefier 1314 is equipped with a temperature control system (not shown), often monitored by thermocouples, to maintain a stable thermal profile along its length. This ensures that the nozzle temperature remains constant for uninterrupted material flow, while the upper regions.

The air injection apparatus 1316 is configured to inject compressed air into the compounding or extrusion zone to form interlaced or air-covered structures along the filament length received from the heated liquefier 1314. The air-injection apparatus 1316 is supplied by a regulated compressed air source operating at a pressure between 1.5 and 4 bar. The air-injection apparatus 1316 is configured with a ring of radial micro-nozzles arranged to direct compressed air around the filament to create circumferential interlacing. The micro-nozzles in the air-injection apparatus 1316 are arranged in a 360-degree circular array and configured to deliver timed pulses of compressed air to form discrete reinforcement points without disrupting filament geometry. The air-injection apparatus 1316 is operatively connected to a valve timing module for generating periodic reinforcement points along the filament. The valve timing module is synchronized with the draw-down roller assembly 1312 speed and is programmed to deliver air bursts at regular intervals based on filament linear velocity.

In one example, the filament passes through a single air injection apparatus 1316 for drying. In another example, the filament passes through a plurality of the air injection apparatus 1316 for drying of the filament.

The compressed air is introduced through the directional nozzles positioned at the extrusion outlet, located at the distal end, to produce turbulence and interlacing. The directional nozzles are positioned at an oblique angle to induce spiral interlacing along the filament surface. Further, the system 1300 is equipped with a sensor module comprising at least one optical micrometer for measuring the filament diameter, a thermal imaging sensor for real-time surface temperature detection, and a load cell or tension detector 1318 for tracking filament tension. The sensor module monitors and logs filament temperature, tension, and interlacing consistency for further processing. The sensor module transmits real-time data to the programmable logic controller (PLC) 1308, which regulates or adjusts extrusion speed, filament cooling, air-injection timing, and winder torque to ensure consistent filament properties. The programmable logic controller (PLC) 1308 includes a touch-screen interface and is programmed to dynamically adjust extrusion parameters in response to feedback from the sensor module or by the user.

The extruded filament is passed through a cooling water bath and/or air-cooled system to solidify the filament. In one example, the system 1300 comprises a diameter sensor for monitoring dimensional accuracy immediately after cooling. In another example, the system 1300 is configured with an optical micrometer for optical monitoring of the filament diameter and interlace distribution. The system 1300 ensures uniform flow and consistent filament diameter. Alternatively, the extruded material is deposited layer by layer onto a build platform (not shown), following precise movements dictated by a computer-generated toolpath. This allows to produce complex geometries by translating digital CAD models into physical objects through a process known as fused filament fabrication (FFF) or fused deposition modeling (FDM).

Further, the draw-down roller assembly 1312 is synchronized with the filament winder 1320 for collecting the filament under control conditions. The air injection apparatus 1316 is synchronized with the filament take-up speed to ensure consistent reinforcement and reduce tension-induced breakage. The filament is guided onto the filament winder 1320, which winds the filament into a coil for storage or subsequent use in 3D printing. The synchronized filament winder 1320 includes an automatic traversing mechanism and variable torque control to evenly distribute filament across the spool and prevent slack or deformation. The interlaced regions formed by air injection reduce brittleness caused by over-drying, excessive fiber content, or improper print settings.

The system 1300 comprises the humidity-controlled storage chamber 1322 for storing the cooled filament. The humidity-controlled storage chamber 1322 is an airtight chamber with desiccant cartridges for storing the filament spool to prevent moisture absorption, brittleness, and preserve filament quality. The humidity-controlled storage chamber 1322 further comprises a temperature regulation, an automated sealing, and logging system for tracking environmental conditions and alerting operators to storage events. The humidity-controlled storage chamber 1322 maintains an internal relative humidity below 15% using the desiccant cartridges and active moisture sensors. The filament is compatible with FFF (Fused Filament Fabrication) 3D printers using nozzles of 0.8 mm or greater and is resistant to clogging or delamination during printing.

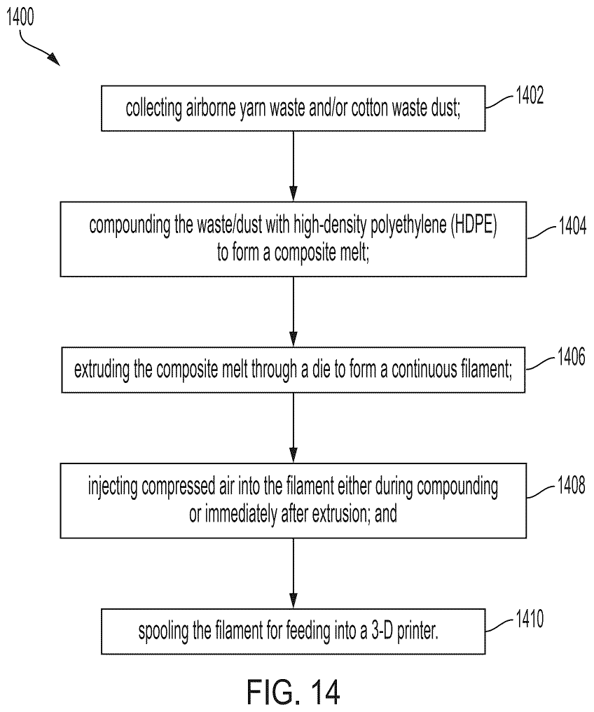

FIG. 14 illustrates a method 1400 for producing a reinforced composite filament for 3D printing in accordance with an embodiment of the present invention. The method 1400 comprises a series of sequential steps designed to efficiently convert airborne yarn waste and/or cotton waste dust into a high-performance composite filament. The method 1400 begins with the step of collecting 1402 airborne yarn waste and/or cotton waste dust (hereinafter referred to as waste/dust) from fabrication or recycling sources. This initial step of collection 1402 ensures that even fine, airborne fibrous residues are effectively gathered for subsequent processing, thereby promoting sustainability and reducing environmental waste.

Following the collection, the method 1400 proceeds to the step of compounding 1404 the waste/dust with high-density polyethylene (HDPE) to form a composite melt. The compounding step 1404 occurs at a melt temperature of about 250° C. The HPDE is a type of thermoplastic polymer. In parallel, the method 1400 comprises a step of adding a charcoal additive comprised of at least one of activated charcoal, biochar, or carbon black derived composition in an amount ranging from 0.5 wt % to 1.5 wt %. The compounding ensures thorough mixing and melting of the HDPE, the waste/dust, and uniformly disperses the charcoal additive throughout the matrix to provide homogenous and well-plasticized composite melt.

The next step involves extruding 1406 the composite melt through a die, having a die temperature of about 240° C., to form a continuous filament. The filament is extruded through a 1-2 mm die and sized to the final diameter of approximately 1.8 mm to 1.95 mm. In parallel, the method 1400 includes injecting 1408 compressed air into the filament either during compounding or immediately after extrusion. The air injection is performed using an air-jet system to interlace the composite material, forming air-injected yarn-like reinforcement. This air-jet interlacing enhances the filament's mechanical properties by improving fiber alignment and increasing surface area for better matrix bonding.

The method 1400 then advances to the step of spooling 1410, the filament for feeding into a 3-D printer. This approach provides additional versatility, enabling the production of composite filaments suitable for additive manufacturing technologies.

The resulting composite filament produced by method 1400 includes uniformly dispersed fibers and charcoal additive, and exhibits improved structural strength, dimensional stability, or thermal performance as compared to compositions without the charcoal additive.

The method 1400, further comprises cooling the filament and storing it in an airtight container with desiccant to prevent moisture absorption and brittleness. The filament is compatible with FFF (Fused Filament Fabrication) 3D printers using nozzles of 0.8 mm or greater and is resistant to clogging or delamination during printing.

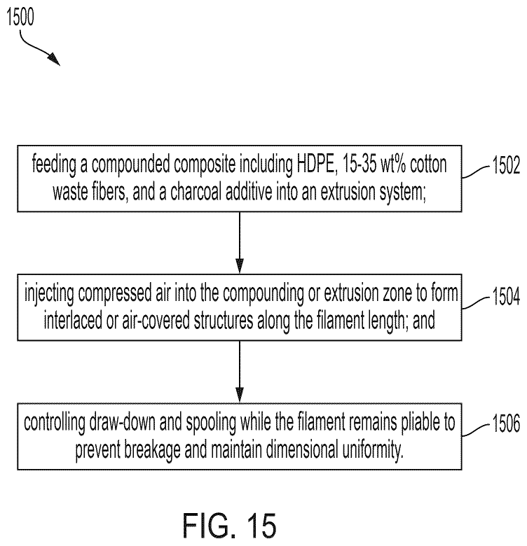

FIG. 15 illustrates a method 1500 for reinforcing a bio-filled 3D printing filament in accordance with an embodiment of the present invention. The method 1500 begins with the step of feeding 1502 a compounded composite including HDPE, 15-35 wt. % cotton waste fibers, and a charcoal additive into an extrusion system.

Following the step of feeding 1502, the method advances to the step of injecting 1504 compressed air into the compounding or extrusion zone to form interlaced or air-covered structures along the filament length. The compressed air is introduced through nozzles positioned at the extrusion outlet to produce turbulence and interlacing. The air-injection system is synchronized with the filament take-up speed to ensure consistent reinforcement and reduce tension-induced breakage.

The interlaced regions formed by air injection reduce brittleness caused by over-drying, excessive fiber content, or improper print settings. Subsequently, the method 1500 includes controlling draw-down and spooling 1506 while the filament remains pliable to prevent breakage and maintain dimensional uniformity. Further, the method 1500 comprises optical monitoring of filament diameter and interlace distribution during spooling to ensure uniformity and quality control.

By following the steps of feeding 1502, injecting 1504, and controlling draw-down and spooling 1506, the method 1500 provides an efficient and scalable approach for reinforcing the bio-filled 3D printing filament.

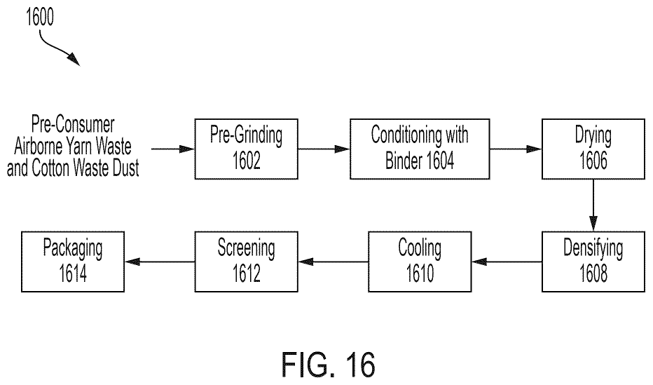

FIG. 16 is a schematic flow diagram 1600 illustrating an exemplary process for manufacturing pelletized cotton waste from pre-consumer airborne yarn waste and cotton waste dust, including pre-grinding, drying, conditioning with binder, densifying, cooling, screening, and packaging steps in accordance with an embodiment of the present invention. This flow 1600 is designed to transform low-density, potentially challenging textile waste into a consistent, easily handleable, and economically viable feedstock for thermoplastic composite manufacturing.

The flow begins with the collection of raw material, specifically airborne yarn waste and/or cotton waste dust obtained from pre-consumer textile fabrication. This source material typically includes fine fibers, lint, short yarn segments, and dust particles generated during various stages of textile production, such as spinning, weaving, knitting, and cutting. Due to its nature, this collected material is often highly heterogeneous in particle size, has a very low bulk density, and may contain varying levels of moisture and trace impurities. The collection is typically performed using industrial dust collection systems, cyclones, baghouses, or similar air filtration technologies.

Following the collection, the material undergoes a pre-grinding stage 1602. This step is crucial for reducing the disparate particle sizes of the collected waste into a more uniform and manageable fibrous consistency. Equipment such as hammer mills, shredders, or refiners may be employed to achieve the desired particle size reduction. Uniformity in particle size is essential for ensuring consistent material flow, efficient drying, effective binder distribution, and ultimately, uniform densification in subsequent steps.

Next, the pre-grinded material proceeds to a drying stage 1604. The purpose of drying is to reduce the moisture content of the cotton waste to an optimal level, typically below a specified percentage, which is critical for several reasons. Excess moisture may impede efficient densification, lead to steam generation and voids during compounding, and potentially cause material degradation or mold growth during storage. Various industrial drying methods, including wet or dry mechanisms, may be utilized, with careful control of temperature and residence time to prevent thermal degradation of the natural fibers.

The dried material is then directed to conditioning with binder 1606. In this stage, the pre-conditioned cotton waste is intimately mixed with a natural or synthetic binder. Examples of suitable binders include starch-based binders, lignin, polyvinyl alcohol, natural resins, waxes, or cellulose derivatives. The binder is critical for promoting inter-fiber adhesion, increasing the mechanical strength of the nascent pellets, and maintaining pellet cohesion during formation, handling, and transport. This mixing can occur in continuous or batch blenders, such as ribbon blenders or paddle mixers, ensuring homogeneous distribution of the binder throughout the fibrous material. In one example, at this stage, a charcoal additive (e.g., activated charcoal, biochar, or carbon black, derived from recycled or biomass sources) may also be incorporated into the formulation. This allows the charcoal to be uniformly distributed within the pellet structure, enabling it to impart odor-absorbing, antimicrobial, or flame-resistant functionality to a resulting composite material.

After thorough conditioning 1606, the material undergoes densifying 1608. This is a pivotal step where the conditioned material is compressed by mechanical or hydraulic densification to form discrete, high-density pellets. Standard densification equipment includes ring-die pellet mills, flat-die pellet mills, briquettes, or extrusion-based densifiers. These machines apply significant pressure to compact the fibers and activate the binder, transforming the low-bulk-density waste into compact, robust pellets. The densification process 1608 ensures that the pellets acquire a generally cylindrical or prismatic shape, with sufficient bulk density and dimensional uniformity suitable for automated metering, stock shipping, and mechanical conveying without disintegration. Furthermore, the pellet surface is physically compacted or densified during this step to reduce friability and minimize dust generation during subsequent handling and storage.

Following densification 1608, the newly formed pellets are cooled 1610. This rapid cooling step is essential to stabilize the pellet's shape, harden the binder, and prevent any agglomeration or deformation that might occur while the pellets are still warm and pliable. Cooling systems, often counter-flow or vibratory coolers utilize ambient air, effectively reduce the pellet temperature, set their structure, and enhance their mechanical integrity.

A subsequent screening step 1612 ensures quality control. Here, the cooled pellets are passed through screens or sieves to remove any undersized “fines” (dust or broken pieces) and any oversized or irregularly shaped particles. This process 1612 is crucial for maintaining the desired dimensional uniformity of the pellets, which is vital for consistent feeding rates in downstream compounding extruders and for achieving predictable material flow during transport and storage. Rejected fines or oversized materials are typically recycled back to the pre-grinding 1602 or conditioning stages 1606 for reprocessing.

Finally, the uniform, high-quality pellets are directed to packaging 1614. The pelletized material is typically stored in sealed or moisture-controlled packaging, such as bulk bags, sacks, or super sacks. This type of packaging is configured for efficient stock shipping and extended storage stability, protecting the pellets from moisture reabsorption, contamination, and physical damage. Once packaged, the pelletized cotton waste is ready for efficient and reliable feeding into polymer compounding extruders, facilitating its use in manufacturing reinforced thermoplastic composites.

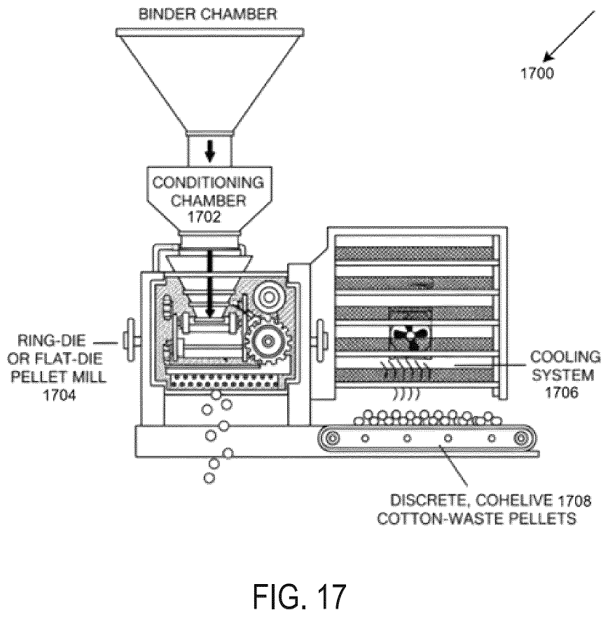

FIG. 17 illustrates a sectional view of an exemplary pelletizing line 1700 showing a ring-die or flat-die pellet mill, conditioning chamber, and cooling system for forming discrete, cohesive cotton-waste pellets in accordance with an embodiment of the present invention. This integrated line 1700 is specifically designed to transform the pre-processed cotton waste into high-quality, uniform pellets suitable for downstream compounding.

The line 1700 begins with a conditioning chamber 1702. The conditioning chamber 1702 serves as a crucial mixing vessel where the pre-ground and dried cotton waste material (from the preceding steps in FIG. 16) is uniformly impregnated or coated with a binder. This binder may be natural (e.g., starch, lignin, molasses) or synthetic (e.g., polyvinyl alcohol, certain thermoplastic resins), configured to promote inter-fiber adhesion and maintain pellet cohesion. The design of the conditioning chamber 1702, often featuring paddles, screws, or agitators, ensures proper and homogeneous dispersion of the binder throughout the fibrous material. This uniform distribution is vital for preparing the material for effective densification, as it promotes the necessary inter-fiber adhesion that maintains pellet cohesion. The conditioning chamber 1702 may also be equipped with systems for precisely controlling moisture and temperature, which further optimize the binder's effectiveness. In one case, an additional additive charcoal (activated charcoal, biochar, or carbon black, derived from recycled or biomass sources) may be introduced to ensure a uniform blend in the pelletized formulation, imparting desired odor-absorbing, antimicrobial, or flame-resistant functionalities to the future composite material.

From the conditioning chamber 1702, the conditioned material is meticulously fed into the heart of the densification process: a ring-die or flat-die pellet mill 1704. The ring-die or flat-die pellet mill 1704 represents the core densification apparatus, responsible for forming the discrete, high-density pellets. While the exact mechanics differ, both ring-die and flat-die designs operate by utilizing intense mechanical or hydraulic compression, which may include mechanical pressing, hydraulic compression, or extrusion-based densification. In a ring-die mill, material is fed into the inner circumference of a rotating die, where rollers force it through radial holes. In a flat-die mill, material is pressed down through holes in a stationary or rotating flat die by rollers. This high-pressure environment compacts the individual cotton waste fibers tightly together. The binder, softened by frictional heat generated during compression, effectively glues these fibers, creating a stable, densified structure. The dimensions of the die openings directly determine the diameter of the pellets. In contrast, the die thickness influences their length, thereby facilitating the creation of pellets with a generally cylindrical or prismatic shape. This ensures the desired bulk density and dimensional uniformity, which are crucial for automated metering, stock shipping, and mechanical conveying without disintegration. Furthermore, the compaction within the mill results in a physically compacted or densified pellet surface, which reduces friability and minimizes dust generation during subsequent handling and storage.

After exiting the pellet mill 1704, the newly formed pellets are typically hot due to the frictional heat generated during compression. Therefore, they are conveyed directly to a cooling system 1706. The cooling system 1706 is essential for rapidly cooling the pellets to stabilize their shape, solidify the binder, and effectively harden the pellet structure. Rapid cooling prevents premature degradation, agglomeration, or deformation of the pellets, ensuring they maintain their structural integrity and desired characteristics. The cooling system 1706 commonly utilizes ambient air drawn over or through the pellets, often in a counter-flow or vibratory cooler. The cooling system or process 1706 is a critical part of the overall method for manufacturing pelletized cotton waste, as it ensures the pellets are robust and cohesive 1708. By solidifying the binder and firming the densified structure, the cooling system 1706 significantly contributes to achieving the desired pellet characteristics, such as reduced friability and minimized dust generation during handling and storage. This also preserves the bulk density and dimensional uniformity required for efficient stock shipping and mechanical conveying.

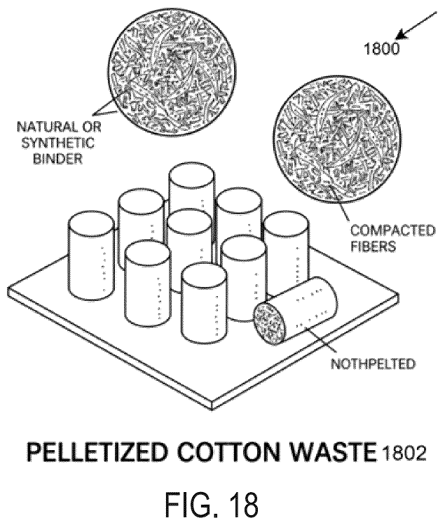

FIG. 18 illustrates a perspective view 1800 of an exemplary pelletized cotton waste 1802, showing uniform cylindrical pellets comprising compacted fibers bound with a natural or synthetic binder in accordance with an embodiment of the present invention. The pelletized cotton waste 1802 represents the final product of the sophisticated manufacturing process (as described in FIGS. 16 and 17). This illustration showcases the critical features of the material that make it a viable and efficient feedstock for thermoplastic composite manufacturing.

The FIG. 1800 clearly illustrates uniform cylindrical pellets 1802, which exhibit consistent shape and dimensions, a key characteristic for automated metering, stock shipping, and mechanical conveying without disintegration. Each pellet 1802 comprises compacted fibers derived from airborne yarn waste and/or cotton waste dust obtained from pre-consumer textile fabrication. These fibers are densely packed and securely bound with a natural or synthetic binder, which was introduced during the conditioning step (as discussed in FIG. 16). The binder ensures strong inter-fiber adhesion, contributing to the pellet's cohesion and structural integrity. The physically compacted or densified surface of these pellets 1802 further reduces friability and minimizes dust generation during handling and storage, enhancing their usability in industrial settings.

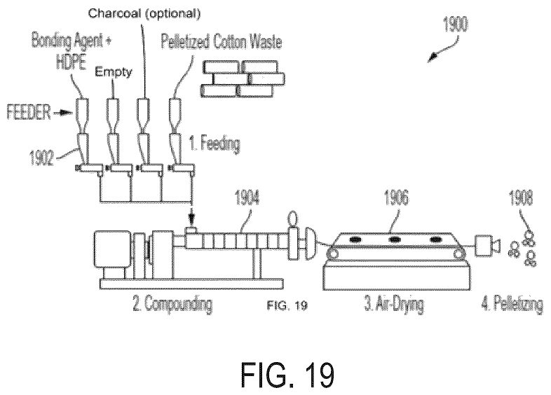

FIG. 19 is a schematic diagram 1900 illustrating an exemplary compounding of pelletized cotton waste with a thermoplastic polymer and bonding agent in a twin-screw extruder, with an optional odor-neutralizing additive introduced through a secondary feeder in accordance with an embodiment of the present invention. This is the subsequent, and crucial step of compounding the pelletized cotton waste into a reinforced thermoplastic composite.

The pelletized cotton waste comprising airborne yarn waste and/or cotton waste dust densified into discrete pellets is fed into the primary feed throat of a feeder 1902 of a twin-screw extruder 1904. The pelletized form ensures efficient and consistent volumetric feeding into the processing equipment.

Simultaneously, a thermoplastic polymer and a bonding agent are introduced into the twin-screw extruder 1904. The thermoplastic polymer is selected from a wide range of materials such as high-density polyethylene (HDPE), polypropylene (PP), polyethylene terephthalate (PET), polycarbonate (PC), polylactic acid (PLA), or polyamide (PA). These polymers form the continuous matrix of the composite. The function of the bonding agent is critical to chemically or physically enhance the interfacial adhesion between the hydrophilic cotton fibers and the typically hydrophobic thermoplastic polymer matrix. Thereby improving the mechanical properties (e.g., tensile strength, impact strength) of the resulting composite.

The twin-screw extruder 1904 is the central processing unit, chosen for its excellent mixing capabilities. The counter-rotating or co-rotating twin screws provide intense heat and high shear forces as the materials are conveyed down the barrel. This robust mechanical action facilitates the thorough melting and plasticization of the thermoplastic polymer, while simultaneously ensuring effective dispersion of the cotton waste pellets and uniform distribution of the bonding agent throughout the polymer melt. The heat generated and applied within the extruder also helps to ensure good wetting of the cotton fibers by the molten polymer and bonding agent, promoting strong interfacial adhesion. This compounding process is where the components are combined under heat and shear to produce a reinforced composite.

An optional odor-neutralizing additive, such as a charcoal additive (e.g., activated charcoal, biochar, or carbon black) which may be derived from recycled or biomass sources, can be introduced into the twin-screw extruder 1904 through a secondary feeder. This secondary feeder allows for precise and controlled dosing of the additive at a specific point along the twin-screw extruder 1904 barrel. The inclusion of this additive serves multiple purposes, enhancing the tensile strength of the composite material while primarily providing crucial odor control functionality. This is particularly beneficial when using recycled materials that might otherwise retain undesirable odors.

The outcome of this intensive compounding process 1904 is a homogenized reinforced composite material. This material is a uniform blend where the densified cotton waste fibers are effectively embedded within the thermoplastic polymer matrix, with the bonding agent ensuring strong adhesion and the optional additive providing enhanced properties. This reinforced composite material is then ready for subsequent processing steps, such as air-drying 1906 to pelletizing 1908.

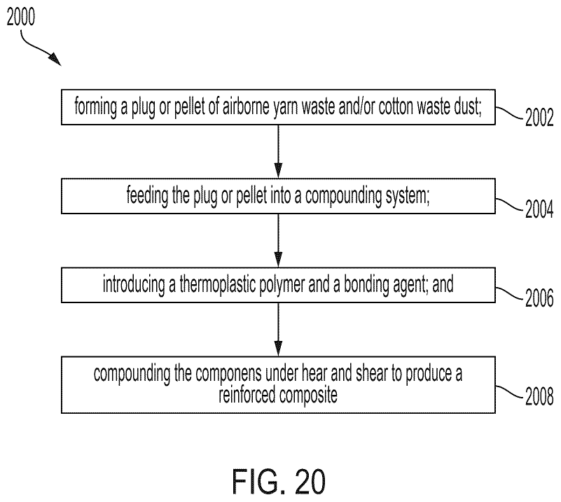

FIG. 20 illustrates a flowchart 2000 showing a process for producing a reinforced thermoplastic composite from pelletized cotton waste, including pellet manufacture, compounding, extrusion, pelletizing or filament formation, and optional 3D-printing utilization in accordance with an embodiment of the present invention. The method comprises the steps of:

Step a: forming pellets (2002)

Airborne yarn waste and/or cotton waste dust is densified to form a flowable “plug,” briquette, or pellet to stabilize bulk density, improve metering, and reduce handling loss of fines before melt compounding. In textile operations, cotton weaving dust and soft fibers are commonly collected and consolidated as briquettes that exhibit favorable dispersion behavior as fillers in thermoplastic matrices, enabling uniform feed and improved processing consistency at low to moderate loadings

Step b: feeding into compounding system (2004)

The formed plugs or pellets are introduced into a thermoplastic compounding system, preferably a co-rotating twin screw extruder configured for distributive and dispersive mixing of natural fibers with a polymer melt, although single screw lines can be used for simpler formulations and re-extrusion steps. Twin screw systems provide higher shear and controlled residence time to deagglomerate fibers, promote uniform distribution, and prepare a homogeneous composite melt before strand take off or die shaping.

Step c: introducing polymer and bonding agent (2006)

A thermoplastic polymer matrix is co-fed with cotton waste pellets and a bonding/compatibilizing agent to enhance fiber matrix interfacial adhesion. Suitable matrices include polypropylene (PP), polylactic acid (PLA), acrylonitrile butadiene styrene (ABS), and related thermoplastics used for extrusion and filament production. In contrast, representative bonding agents include maleic anhydride grafted polyolefins (e.g., MAPP) or other coupling agents known for natural fiber composites.

Step d: compounding under heat and shear (2008)

The combined cotton waste, polymer, and bonding agent are melt-compounded under controlled temperature profiles and screw configurations to impart sufficient shear for fiber wet-out and dispersion. This process avoids thermal or hydrolytic degradation, thereby producing a reinforced thermoplastic composite ready for pelletizing or direct shaping. During compounding, fiber bundles are fibrillated and size reduced by kneading elements, which promotes network formation and stress transfer in the matrix, with process conditions selected to balance viscosity, residence time, and fiber integrity.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art that although the preferred and alternate embodiments have been shown and described in accordance with the Patent Statutes, the invention is not limited thereto or thereby.

The terminology used herein is for the purpose of describing particular embodiments only and is not intended to be limiting to the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention and some of its advantages have been described in detail for some embodiments. It should also be understood that various changes, substitutions, and alterations can be made herein without departing from the spirit and scope of the invention as defined by the appended claims. An embodiment of the invention may achieve multiple objectives, but not every embodiment falling within the scope of the attached claims will achieve every objective.

1. A pelletized cotton waste formulation for use in thermoplastic composite manufacturing, the formulation comprising:
airborne yarn waste and/or cotton waste dust obtained from pre-consumer textile fabrication; and
a densified pelletized structure formed by mechanical or hydraulic compression of the waste/dust into discrete pellets configured for feeding into a polymer compounding extruder.

2. The formulation according to claim 1, further comprising a natural or synthetic binder configured to promote inter-fiber adhesion and maintain pellet cohesion during transport.

3. The formulation according to claim 1, wherein the pellets have a generally cylindrical or prismatic shape and are configured with bulk density and dimensional uniformity suitable for automated metering, stock shipping, and mechanical conveying without disintegration.

4. The formulation according to claim 1, further comprising a charcoal additive selected from activated charcoal, biochar, or carbon black derived from recycled or biomass sources.

5. The formulation according to claim 4, wherein the charcoal additive imparts odor-absorbing, antimicrobial, or flame-resistant functionality to a resulting composite material.

6. The formulation according to claim 1, wherein the pellet surface is physically compacted or densified to reduce friability and minimize dust generation during handling and storage.

7. A method for manufacturing pelletized cotton waste, comprising:
collecting airborne yarn waste and/or cotton waste dust from pre-consumer textile fabrication;
pre-grinding and drying the collected material;
mixing the material with a binder;
compressing the conditioned material by mechanical or hydraulic densification to form discrete pellets; and
cooling and packaging the pellets for downstream compounding.

8. The method of claim 7, wherein the densification is performed using at least one of mechanical pressing, hydraulic compression, extrusion-based densification, or thermal bonding.

9. The method of claim 7, wherein the pellets are cooled and screened to remove fines and maintain dimensional uniformity.

10. The method of claim 7, wherein the pelletized material is stored in sealed or moisture-controlled packaging configured for stock shipping and extended storage stability.

11. A reinforced thermoplastic composite comprising:
a thermoplastic polymer;
a bonding agent; and
pelletized cotton waste comprising airborne yarn waste and/or cotton waste dust obtained from pre-consumer textile fabrication, the waste being densified by mechanical or hydraulic compression into discrete pellets; wherein the pellets are compounded with the thermoplastic polymer and bonding agent to form a reinforced composite material.

12. The composite of claim 11, wherein the bonding agent comprises a maleic-anhydride-grafted polymer or compatibilizer.

13. The composite of claim 11, wherein the thermoplastic polymer is selected from high-density polyethylene, polypropylene, polyethylene terephthalate, polycarbonate, polylactic acid, or polyamide.

14. The composite of claim 11, further comprising a charcoal additive introduced during compounding to enhance tensile strength and odor control.

15. The composite of claim 14, wherein the charcoal additive is derived from pyrolyzed agricultural waste including coconut shells, rice husks, bamboo, or walnut shells.

16. The composite of claim 11, wherein the compounded composition is pelletized through extrusion to form pellets configured for molding, extrusion, or three-dimensional printing.

17. The composite of claim 16, wherein the compounded composition is alternatively extruded into a continuous filament suitable for spooling and additive-manufacturing applications.

18. A method for producing a reinforced composite material, comprising:
forming a plug or pellet of airborne yarn waste and/or cotton waste dust;
feeding the plug or pellet into a compounding system;
introducing a thermoplastic polymer and a bonding agent; and
compounding the components under heat and shear to produce a reinforced composite.

19. The method of claim 18, further comprising pelletizing the compounded material and drying the pellets before molding or extrusion.

20. The method of claim 18, further comprising molding or extruding the dried pellets to form an article.
